(19) United States
(12) Patent Application Publication
(10) Pub. No.: US 2010/0241493 A1
(43) Pub. Date: Sep. 23, 2010

(54) COMPUTERIZED VOTING SYSTEM

(76) Inventor: DANIEL WILLIAM ONISCHUK, Edmonton (CA)

Correspondence Address: DAN ONISCHUK, 9628 100A ST, EDMONTON, AB, T5K 0V8, CA

(21) Appl. No.: 12/793,694

(22) Filed: Jun. 4, 2010

Related U.S. Application Data
(63) Continuation of application No. 12/537,657, filed on Aug. 7, 2009, now abandoned.
Application No. 12/537,657 is a continuation of application No. 12/475,444, filed on May 29, 2009, now abandoned.
Application No. 12/475,444 is a continuation of application No. 12/131,085, filed on May 31, 2008, now abandoned.
Application No. 12/131,085 is a continuation of application No. 11/765,310, filed on Jun. 19, 2007, now abandoned.

(30) Foreign Application Priority Data
Jul. 4, 2004 (CA) 2,469,598

(51) Int. Cl. G06Q 10/00; G06Q 90/00; G06K 7/00; G06F 21/22; H04L 9/30

(52) U.S. Cl. 705/12; 705/500; 235/380; 726/4; 380/28

(57) ABSTRACT

Any business, individuals, groups of people, or government that is Officially facilitating the voting process use sources of computer data and other data to create lists of every eligible Voter. The List of Eligible Voters contains the name and physical mailing address for each Voter. The Official host then arranges for printing of mailing envelopes containing specially designed ballots to the Voters. Each MASTER Ballot has two parts—a PRIMARY Ballot and at least one RECEIPT Ballot. For each MASTER Ballot, both the PRIMARY Ballot and RECEIPT Ballot(s) share an identical, unique group of symbols as a correlating identifier. The identifier (RSID) is randomly generated to be unique and rare, so as to make any ballot difficult to counterfeit. To maintain privacy, before voting, Voters exchange ballots any number of times within a voting region. Ballot validation prior to exchange is performed in person, by telephone, fax or Internet. Completed PRIMARY Ballots are mailed or otherwise delivered via Internet, Telephone, Fax or Email to Official host on or before the due date for verification, recording, tallying and publication. By referring to any RECEIPT Ballot having the same the unique RSID as the PRIMARY Ballot, any Voter can use a telephone or a computer connected to the Internet to enquire, verify or report errors as to processing of their PRIMARY Ballot, or published tallies of ballot votes or other information published. After voting is completed, Officials publish a list of all the Ballot Voting RSID's, so that anyone can verify any Ballot, Voter selections Ballots, the tally for each Ballot, etcetera. The Voting System may optionally be supported by physical ballots (paper, plastic, etc.) for immutable secondary verification of electronic votes; thus providing a transparent, verifiable audit trail to assure completeness, accuracy and validity of the Voting Session.

### PURPOSE OF INVENTION

Secure Processing of Voting Ballots

### TECHNICAL PROBLEMS RESOLVED

1. improve accuracy, time and money savings of compiling voter lists;
2. extend the process of voting to encompass more voters by providing significantly easier access to the process of voting;
3. extend the process of voting to encompass candidates, proposals or any combination of candidates and proposals;
4. maintain security, privacy and anonymity of voter ballots cast;
5. enable voters to anonymously verify and correct the accuracy of official records of any ballots they have cast, by using electronic devices connected to communications networks;
6. prevent counterfeit ballots by special security elements and methods;
7. enable voters to verify ballots authenticity and validity by using electronic devices connected to communications networks;

### INVENTION USES

1. Elections to select political candidates to Government duty.
2. Corporate group of stockholders vote to elect a Chief Executive Officer.
3. Public vote on passing a Government Bill Proposal as a Public Law.
4. Stockholders vote to accept or reject proposals on business activities.

### BACKGROUND OF INVENTION

Although this invention was conceived without reference to existing patents, this invention differs from several existing patents significantly. The purpose of this patent is to overcome the following issues and limitations of existing patents:

### CROSS REFERENCE TO RELATED APPLICATIONS

| | | | | | |
|---|---|---|---|---|---|
| 3,141,976 | May 1974 | Hune | 6,688,517 | February | McClure |
| | | | | 2004 | |
| 6,640,138 | April 2003 | Hall & | 6,457,643 | October | May |
| | | Schwartz | | 2002 | |
| 6,722,562 | April 2004 | Weiss | 6,726,090 | April 2004 | Kargel |

Although Hall & Schwartz et al—U.S. Pat. No. 6,054,0138 refer to the use of scanning devices and scannable barcodes, the barcodes themselves are not easily human readable, nor easily compatible with translation for telephone use. Furthermore, the process of Hall & Schwartz et al implicitly violates Voter privacy as the there are means to link any persons vote to the ID number they are assigned for voting, such as visual observations of ID number, electronic interception of a generated ID number. Any Voter can also be linked to a ballot by witnesses as to the date, time and place where the ballot is cast. The same implication of linking of a specific ballot to a specific Voter can also be said for the patent of Way—U.S. Pat. No. 6,457,643 Way remarks “7. A ballot paper as claimed in claim 5 or claim 6 wherein the unique identifier is generated from a Voter's position on an electoral roll, the date and time the ballot paper was issued, and an external value contributed by a key.”; Thus Officials could know when & where the specific ballot identifier was issued to a specific person, therefore the alleged privacy is penetrable through observation and deduction. Electronic surveillance technology could be used to detect electromagnetic waves emitted from devices issuing IDs which could then be sent to a portable computer that use software to determine an ID.

The patent of Weiss U.S. Pat. No. 6,722,562 involves the use of Automated Teller Machines also links a Voter to a specific card and their personal identity number (PIN). Although ATM voting cards could be exchanged among Voters, ATM machines have cameras which would record the Voters face, along with the location, date and time of the ballot cast from that particular ATM. The massive coordination of banks with government. computer software adaptation and privacy issues may prevent adopting this method. Furthermore, the magnetic field of ATM cards may be easily corrupted by mistake or intent.

Due to some similarities, it should be re-emphasized that this patent was developed without prior knowledge of Kargel U.S. Pat. No. 6,726,090 or any of the other patents. Yet, this invention overcomes many disadvantages of Kargel and other patents by specifically defining unique methods of:

a. creating computer data lists to identify eligible Voters;
b. unique identifiers to trace/link Registration Forms to Voters;
c. unique identifiers to trace/link Ballots distribution to Voters;
d. providing Voters with information to facilitate voting;
e. decoupling Voters from specific ballots to provide vote anonymity;
f. collecting ballots and registrations from Voters and tracking the items received;
g. telephonic and/or internet voting that does not enable the Official person to link a specific ballot ID to a specific Voter (in Kargel, Official person does not know if the Voter is legitimate, cannot protect Voter privacy when using an identifiable ballot)
h. to use unique identifiers to distinguish PRIMARY Ballots and their duplicates to prevent multiple voting using both ballots at different voting locations;
i. of using at least one computer or telephone communication network; to facilitate ballot issuance, ballot replacement, ballot Validation, private verification of voting;
j. ensuring ballots may not be counterfeited, to prevent unfair influence in results;
k. providing ballots with Security Elements to assist with Authentication;
l. providing symbols and data on the ballot to reduce human processing;
m. voting to include people, proposals, or, any combination of people, proposals.
n. providing an expiry time and/or date on the ballot to limit ballot use;
o. providing additional information on the ballot to facilitate accurate completion;
p. providing additional information to help the Voter via a Voter Information Forms;

After considering Hune—U.S. Pat. No. 3,941,976 it should be noted this invention also adds:

(i) assists the principles of democracy by making it easier for people to participate in voting, enabling the more accurate representation of Voters choices.
(ii) ensures the integrity of the ballots so that the processing and voting selections may be verified and adjusted by the Voter and Official persons upon detection of any processing errors after the ballot has been processed.
(iii) use of a Random Symbolic ID (RSID) and other security elements and processes so as to ensure the integrity of Ballots so that a MASTER, PRIMARY, or, RECEIPT Ballot (and/or Voter Registration Form) may not be easily duplicated, in any quantity to significantly affect the overall percentage of vote tallies, and any such duplicates would be immediately detected and removed for investigation and authentication so as guarantee the integrity of the final tally and certified results.
(iv) additional security by use of n-dimensional matrices whose elements are accessed by encoding-decoding constituent components of VOTING RSID's or other Security Elements, are evaluated to determine data accuracy and/or authenticity.

### SUMMARY OF INVENTION

The present invention provides a method and system that improves and extends the tasks of certifying eligible voters, voter participation, ensuring accurate vote reception, tallying, verification, and error reporting. The major components of the method involve providing specially designed Ballots to a group of voters; recording Ballots received from the group of voters; tallying the votes from Ballots that were authenticated and validated; publishing the vote tallies from the group; verifying the published Ballot votes and tallies on a per-voter basis; and certifying the groups tallied Ballot votes were accurately recorded and counted. Systems are also taught herein for accomplishing these tasks in many ways, namely by use of:

1. acquiring information from computer databases and other sources to organize and construct any number of Lists of Eligible Voters; and furthermore, Lists of Officials, and other data relevant to the Voting Session.
2. a Paper Voting method employing the use of a carbon copy or carbonless copy paper MASTER Ballot which comprises of a unique identifier; furthermore that this identifier be extremely difficult to guess, such as, but not limited to: Random Symbolic Identifiers, or, sequential series of unique identifiers, or, a hybrid of random and sequential identifiers;
3. specially designed Security Elements for authentication and Limits of Use data;
4. optical barcodes and other codes to facilitate computer processing;
5. Telephone Voting methods described herein this invention;
6. electronic facsimile (FAX) Voting methods described herein this invention;
7. Internet Voting methods (such as, but not limited to: secure web-pages) described herein;
8. audio voting methods;
9. video voting method with optional audio voting methods;

However, the particular systems discussed herein are given as some of the illustrations of particular embodiments of the invention. Other embodiments of the invention are expected to employ differing degrees of automation in providing, validating, authenticating, recording, tallying, publishing, certifying recorded and tallied votes. The systems taught and described herein are not intended to limit the application of the method claimed. The method of the invention must involve instrumentalities and combinations having different manifestations of representation, physical sizes and characteristics to suit the many corresponding physical limitations, abilities, and requirements that bear on a particular voting session or the available technology used to achieve some purpose for any voting session. The spirit of this invention will be fulfilled as long as the principles of ensuring all Eligible Voters have anonymity when casting their initial ballots, and may anonymously verify or report errors regarding the record of their ballots, thus ensuring the election system provides the intended equality for each vote cast. Accordingly, it is an object of the present invention to provide a voting method and system that allows one or more voters to completely verify the accurate recording, tally and publication of each vote on any Proposal or Candidate or any number of combinations of candidates and proposals; and it is a further object of the invention to provide: (a) a voting method and system that allows each Voter and Official to verify their votes on any Proposal or Candidate was correctly recorded, tallied and published; (b) each voter with a private receipt ballot record of the voter's primary ballot vote; (c) a public post-polling record of all votes cast on a proposal or candidate; (d) the capability for voters to use their private receipt ballot records of their cast primary ballot votes to verify or authorize correction of the public record of all ballots and votes cast; (e) the capability for voters to use the verified or corrected public record of all votes cast to verify or authorize correction of the tallies or summaries of votes; (f) vote verification and/or vote correction capabilities in a voting method or system that utilizes any physical, or, electronic, or, optical means of providing, receiving, recording validating, verifying, authenticating, tallying, summarizing, publishing and certifying: votes, ballots records, tallies, summaries or results; (g) a voting system the capability for voters to use the records of all Eligible Voters to verify or authorize correction of their name and contact information to any list of Eligible Voters; (h) vote verification and/or vote correction capabilities in a voting method or system that utilizes any physical, or, electronic, or, optical means of providing, receiving, recording validating, verifying, authenticating, tallying, summarizing, publishing and certifying any records, tallies, summaries or publications of any List of Eligible Voters. In addition to the foregoing, further, objects, features, and advantages of the present invention should become more readily apparent to those skilled in the art upon a reading of the following detailed description in conjunction with the drawings, wherein there are shown and illustrated as examples of embodiments of the invention. It is evident that those skilled in the art may now make numerous other uses and modifications of and departures from the specific embodiments described herein without departing from the inventive concepts. Consequently, this invention is to be construed as embracing each novel feature or novel combination of novel features present in or possessed by the methods and techniques herein disclosed and is not to be limited to the spirit or scope of these descriptions, disclosures, appended claims or drawings.

There are 31 (THIRTY-ONE) drawings included for this invention.

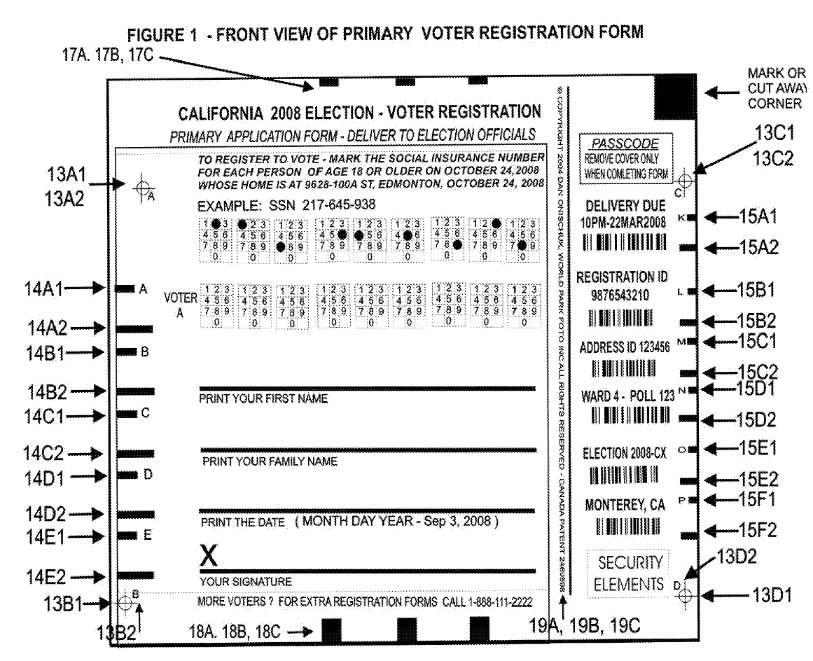

FIG. 1: a site plan view for the FRONT side of a first embodiment of a PRIMARY part of a Master Voter Registration Form of the invention.

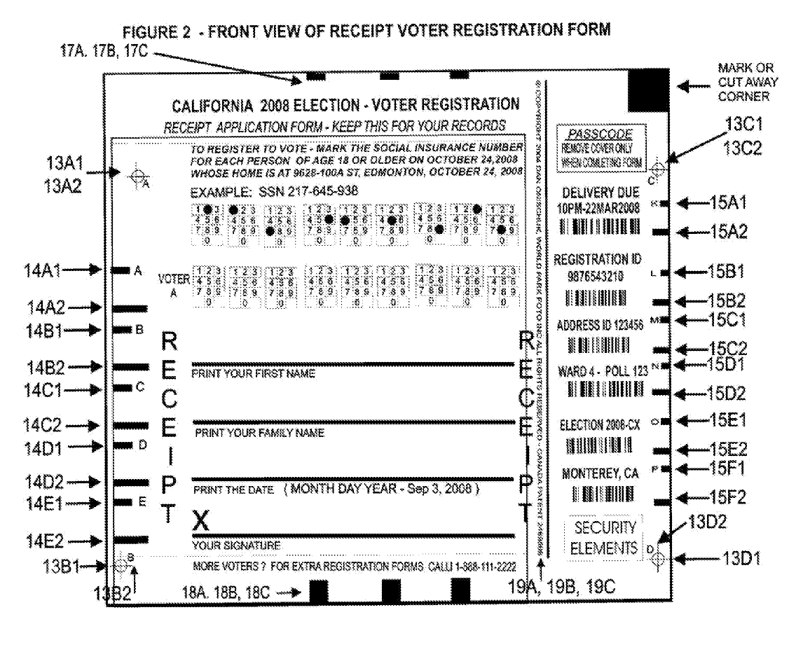

FIG. 2: a site plan view for the FRONT side of a first embodiment of a RECEIPT part of a Master Voter Registration Form correlated to FIG. 1 of the invention.

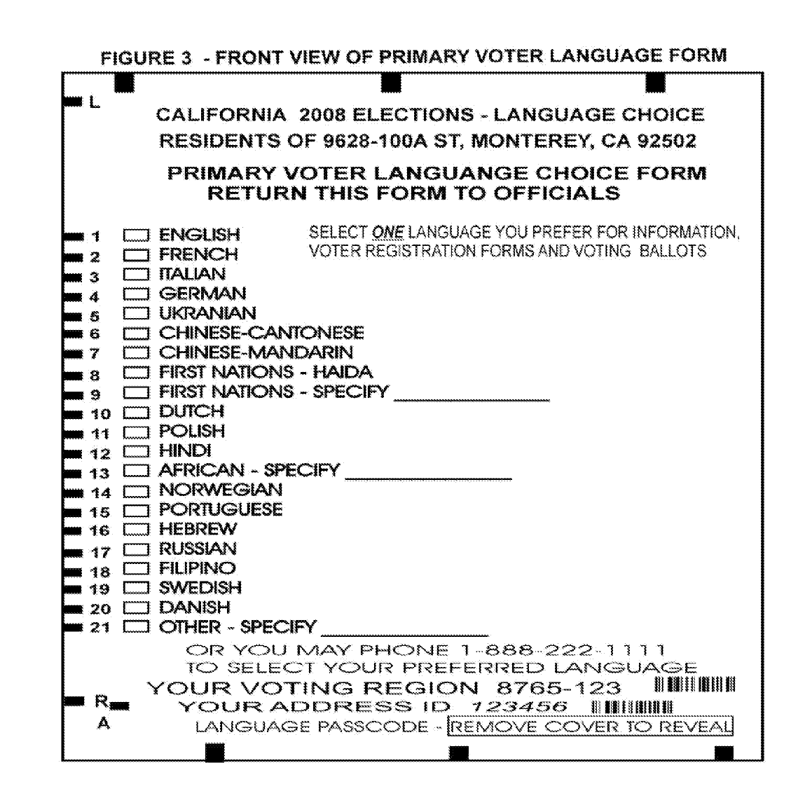

FIG. 3: a site of view for the FRONT side of a first embodiment of a PRIMARY part of the Master Voter Language Registration of the invention;

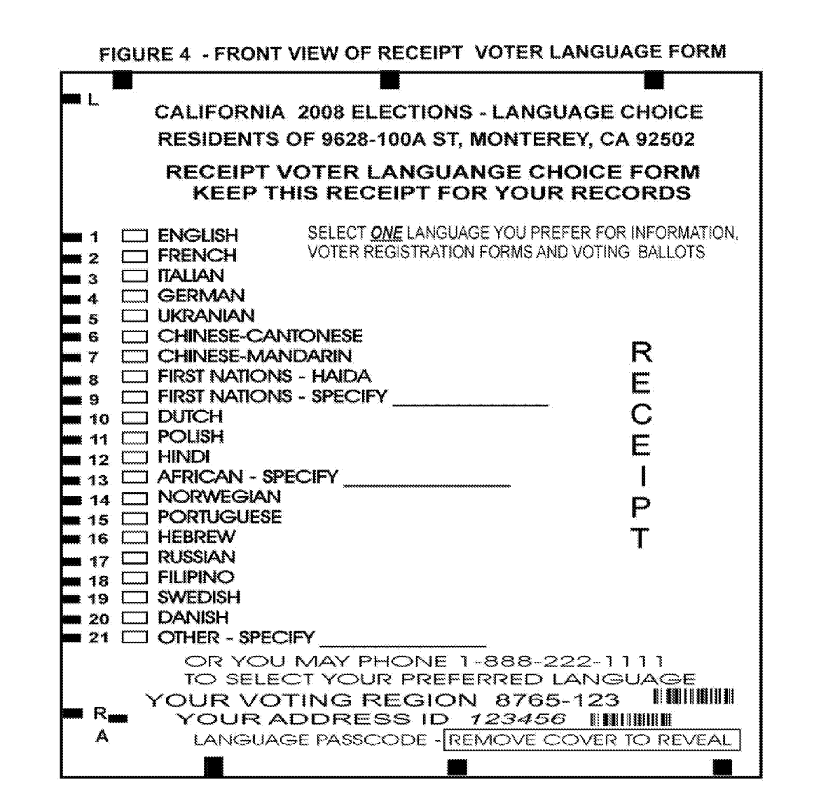

FIG. 4: a site of view for the FRONT side of a first embodiment of a RECEIPT part of the Master Voter Language Registration correlated to FIG. 3 of the invention;

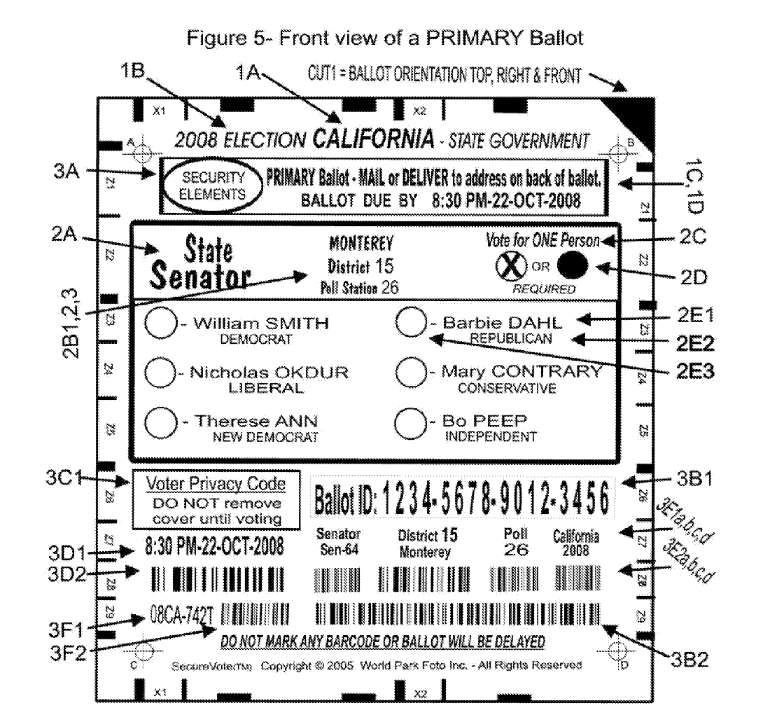

FIG. 5: a site plan view for the FRONT side of a first embodiment of a PRIMARY part of a Master Ballot of the invention.

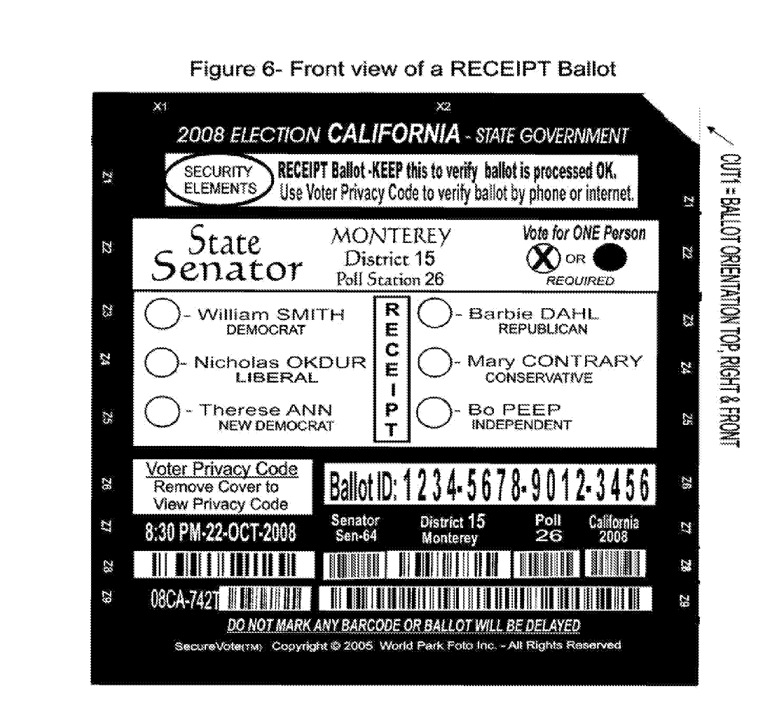

FIG. 6: a site plan view for the FRONT side of a first embodiment of a RECEIPT part of a Master Ballot correlated to FIG. 5 of the invention.

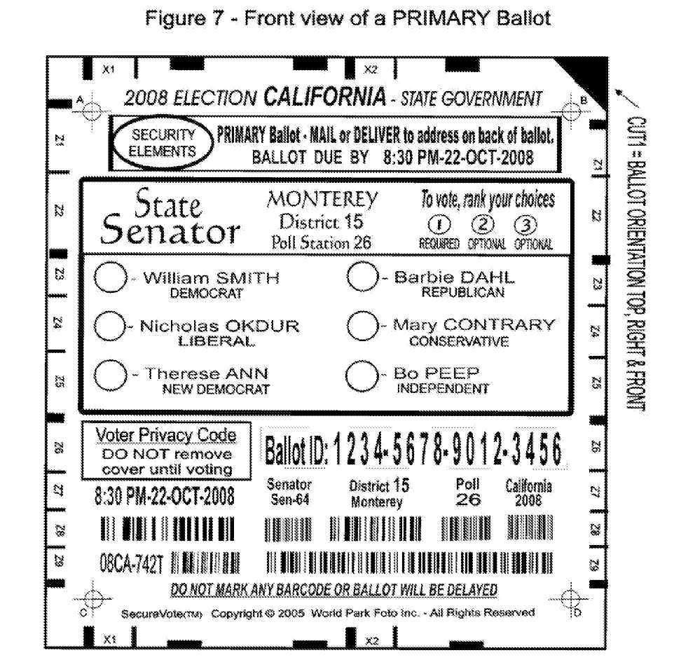

FIG. 7: a site plan view for the FRONT side of a second embodiment of a PRIMARY part of a Master Ballot of the invention;

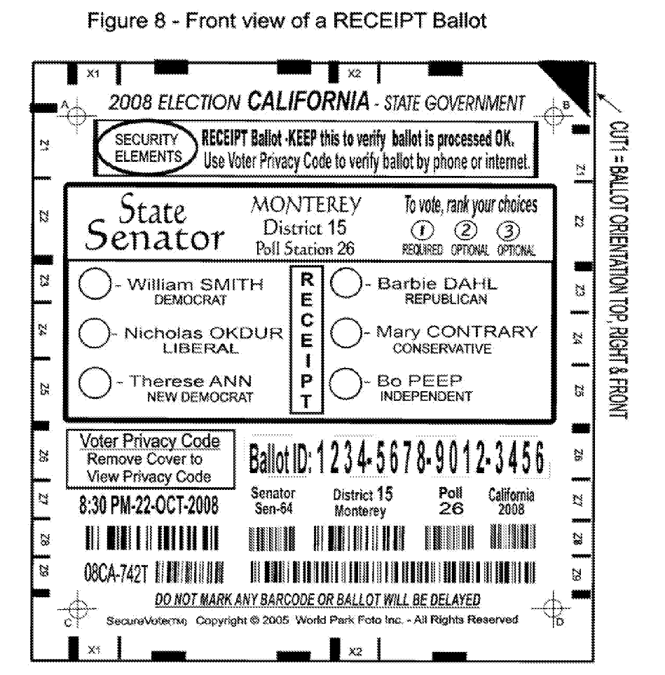

FIG. 8: a site plan view for the FRONT side of a second embodiment of a RECEIPT part of a Master Ballot correlated to FIG. 7 of the invention.

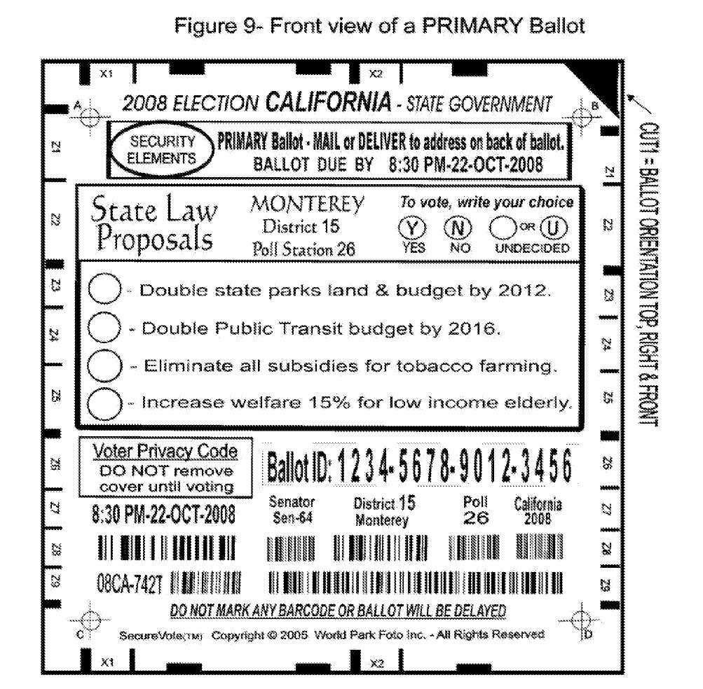

FIG. 9: a site plan view for the FRONT side of a third embodiment of a PRIMARY part of a Master Ballot of the invention;

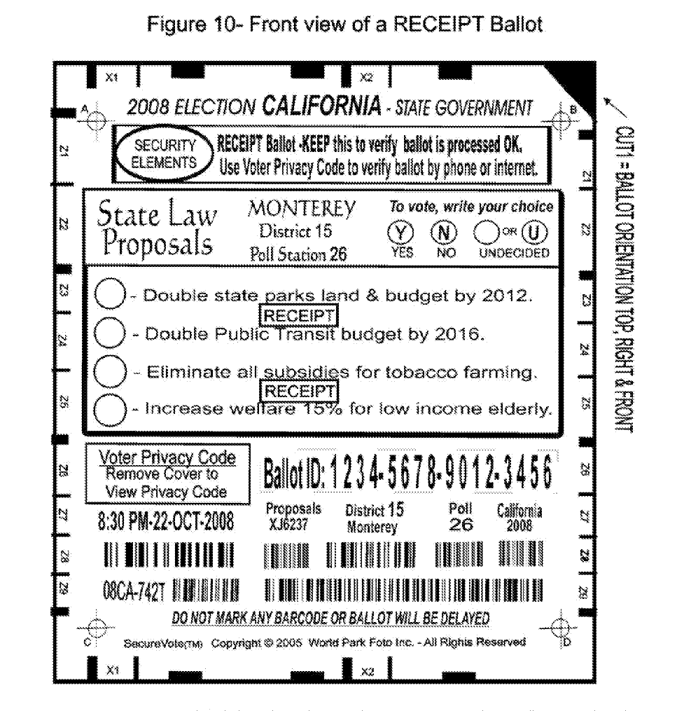

FIG. 10: a site plan view for the FRONT side of a third embodiment of a RECEIPT part of a Master Ballot correlated to FIG. 9 of the invention.

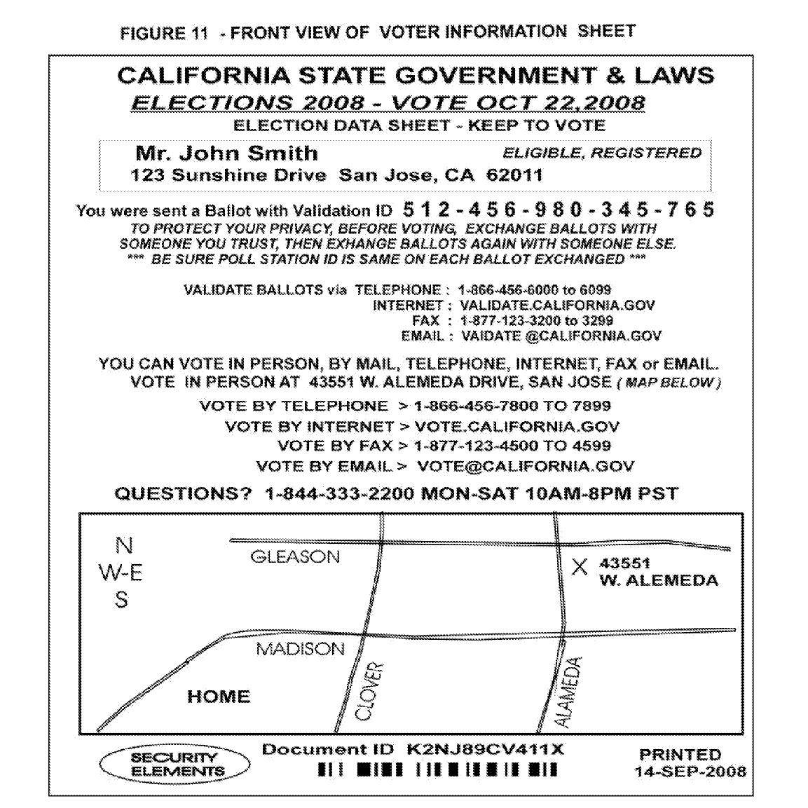

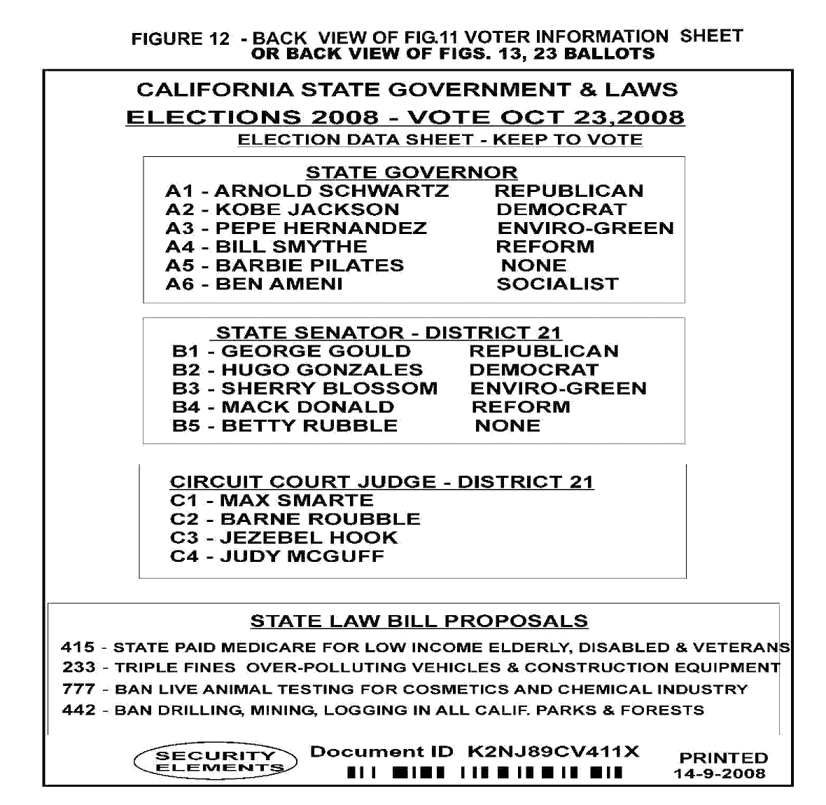

FIG. 11: a site plan view for the FRONT of a first embodiment the Voter Ballot Information Sheet document of the invention.

FIG. 12: a site plan view for the BACK side of a first embodiment of a Voter Ballot Information Sheet, correlated to FIG. 11 of the invention.

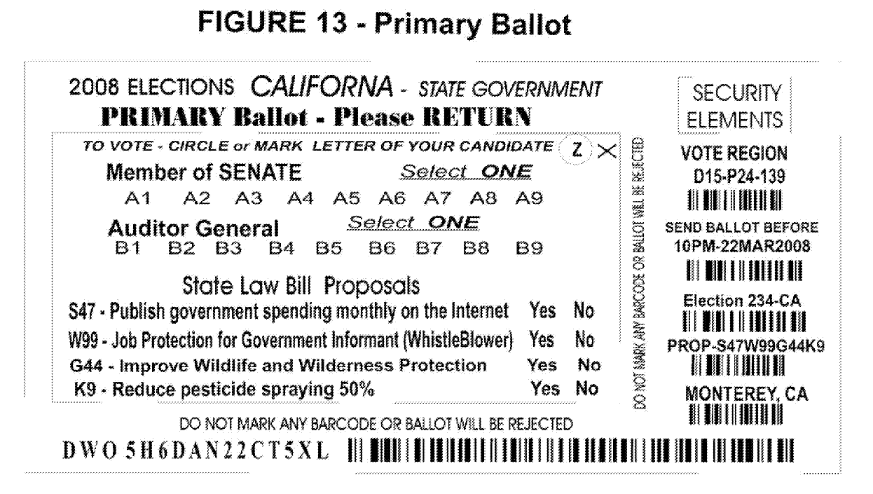

FIG. 13: a site plan view for the FRONT side of a fourth embodiment of a PRIMARY Ballot of the invention.

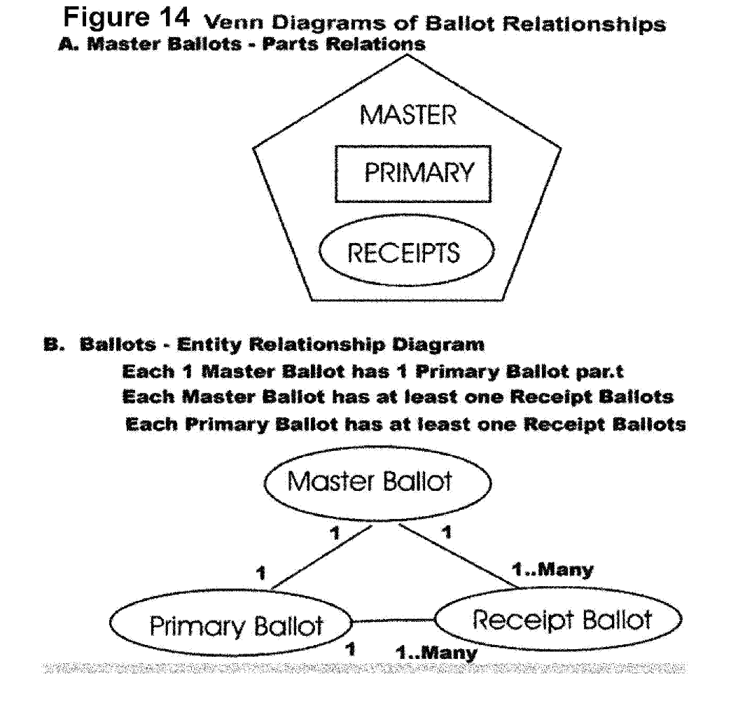

FIG. 14: a site plan view of a first embodiment of a Venn Diagram of Ballot Relationships and Master Ballot Parts of the invention.

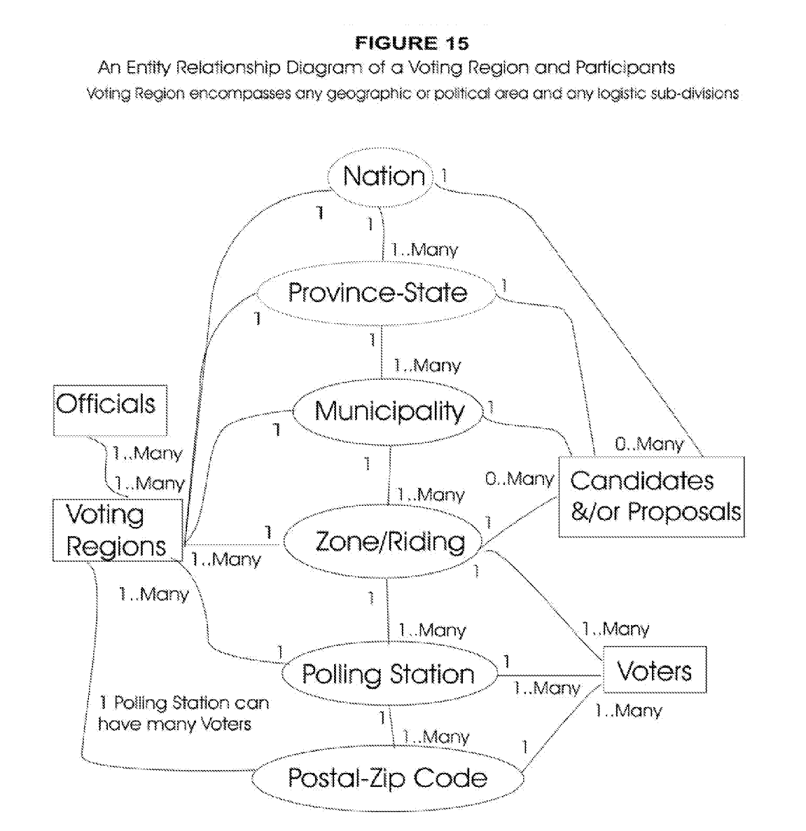

FIG. 15: a site plan view of a first embodiment of an Entity Relation Diagram of Voting Regions and Participants of the invention.

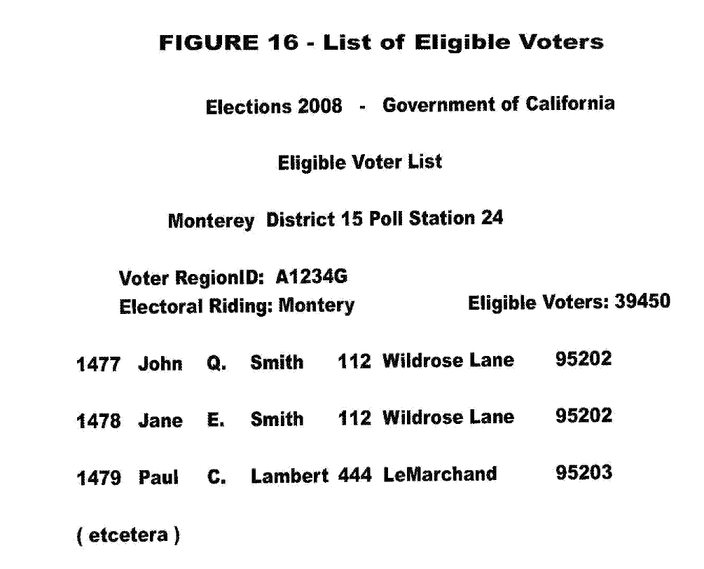

FIG. 16: a site plan view of a first embodiment of a List of Eligible Voters of the Invention.

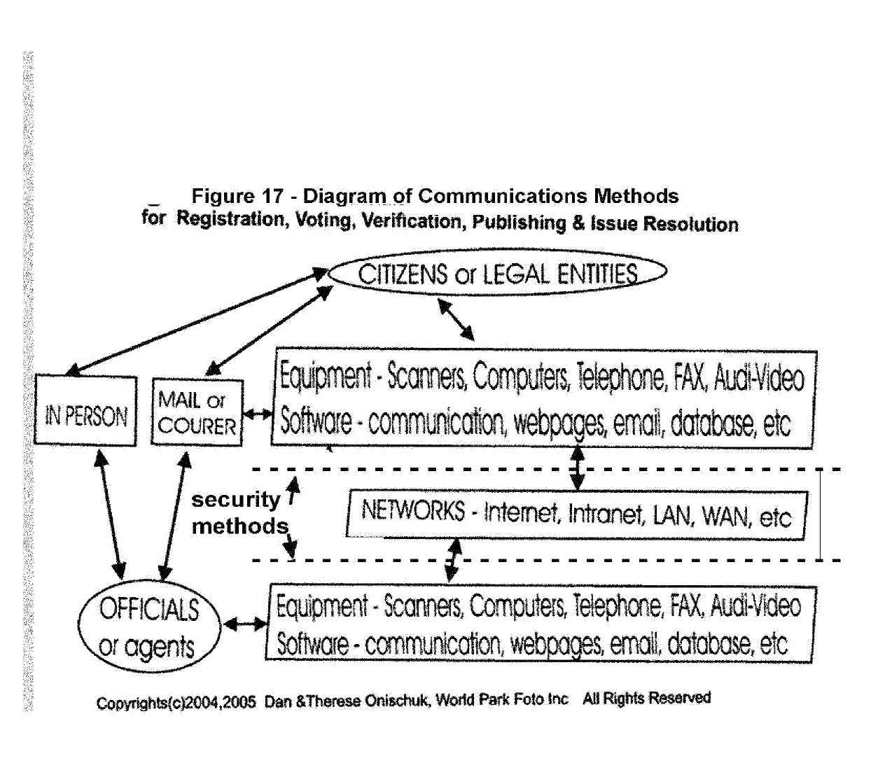

FIG. 17: a site plan view of a first embodiment of a Diagram of Communication Methods for Registration, Voting, Verification, Publishing and Issue Resolution of the invention.

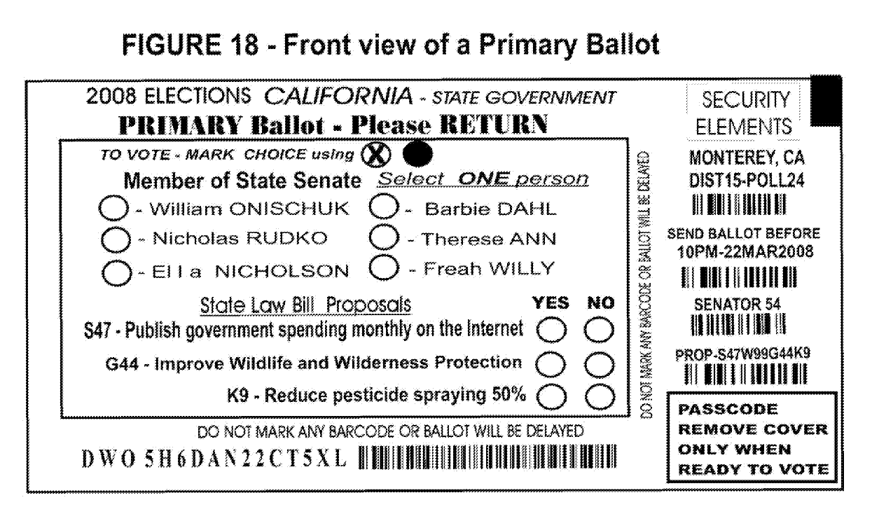

FIG. 18: a site plan view for the FRONT side of a fifth embodiment of a PRIMARY Ballot of the invention.

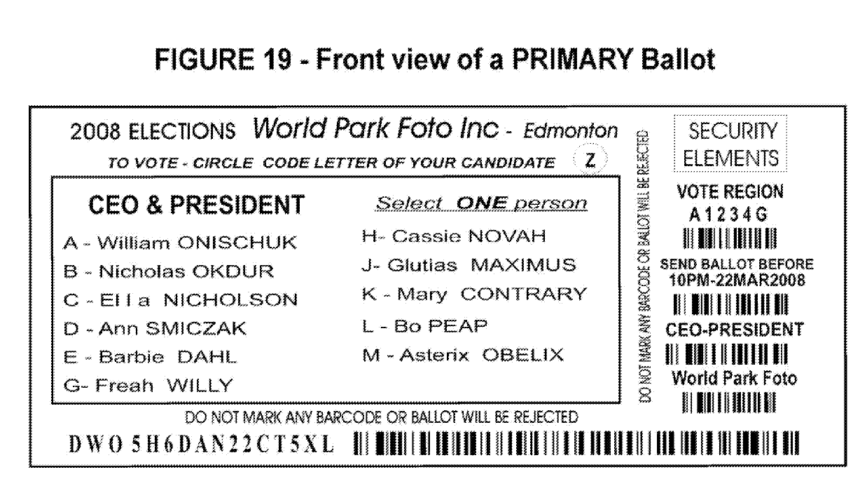

FIG. 19: a site plan view for the FRONT side of a sixth embodiment of a PRIMARY Ballot of the invention.

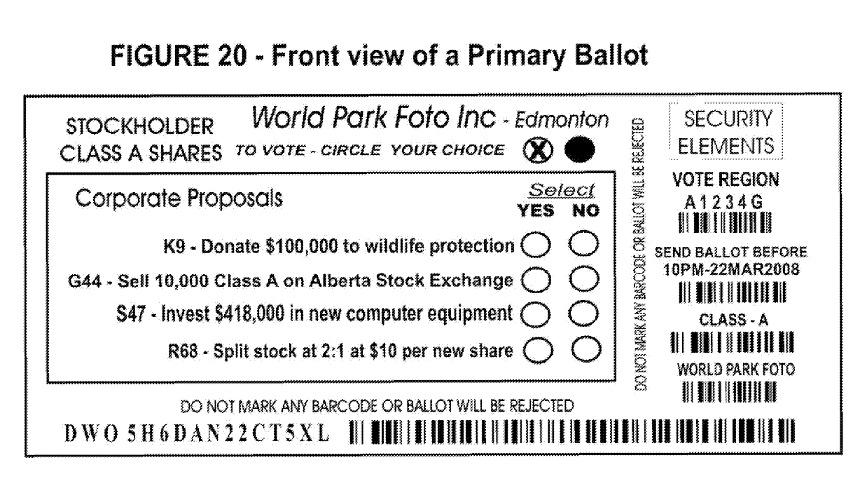

FIG. 20: a site plan view for the FRONT side of a seventh embodiment of a PRIMARY Ballot of the invention.

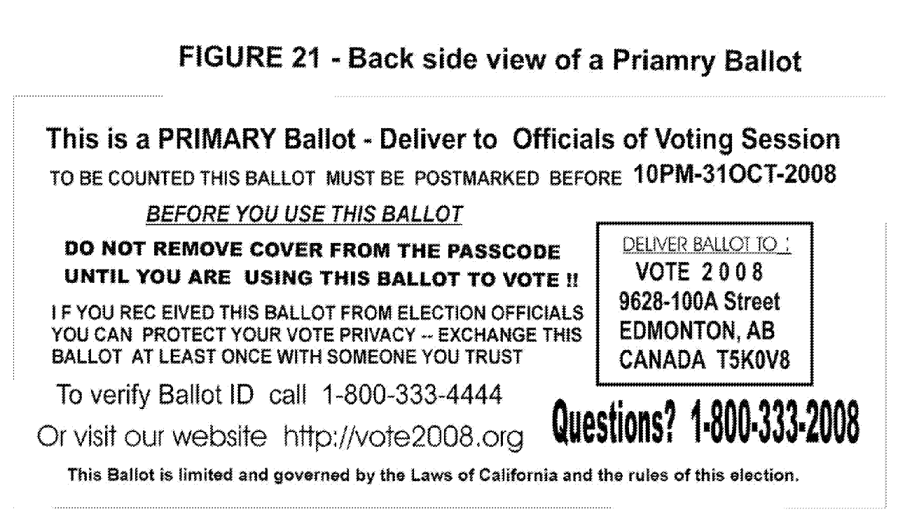

FIG. 21: a site plan view for the BACK side of a first embodiment of a PRIMARY Ballot, correlated to FIGS. 5,9,13,18,19,20,23 of this invention; and with further modification, FIG. 21 may then be correlated to FIG. 1 for Voter Registration forms FIGS. 1,2, and/or correlated to FIGS. 3,4 for the Voter Language forms of this invention;

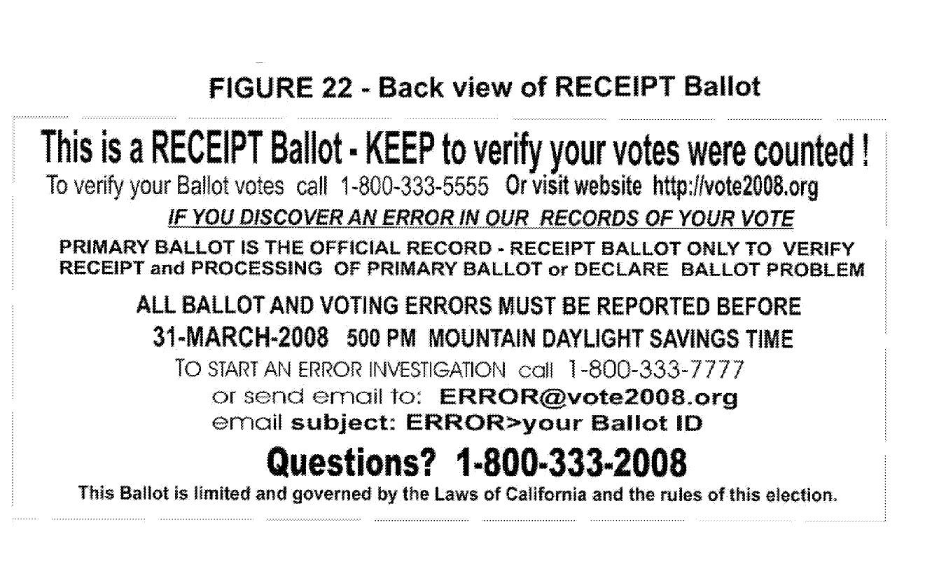

FIG. 22: a site plan view for the BACK side of a first embodiment of a RECEIPT Ballot, correlated to FIGS. 6,8,10 of this invention; and with further modifications, FIG. 22 may be correlated to FIG. 2 for Voter Registration forms FIGS. 1,2, or, FIGS. 3,4 for Voter Language forms of this invention;

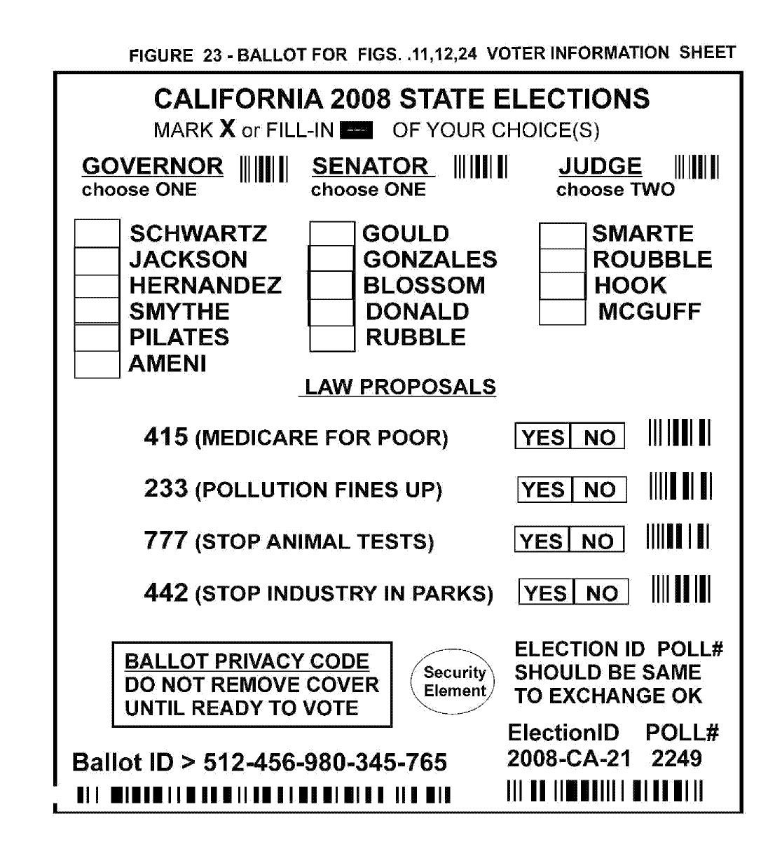

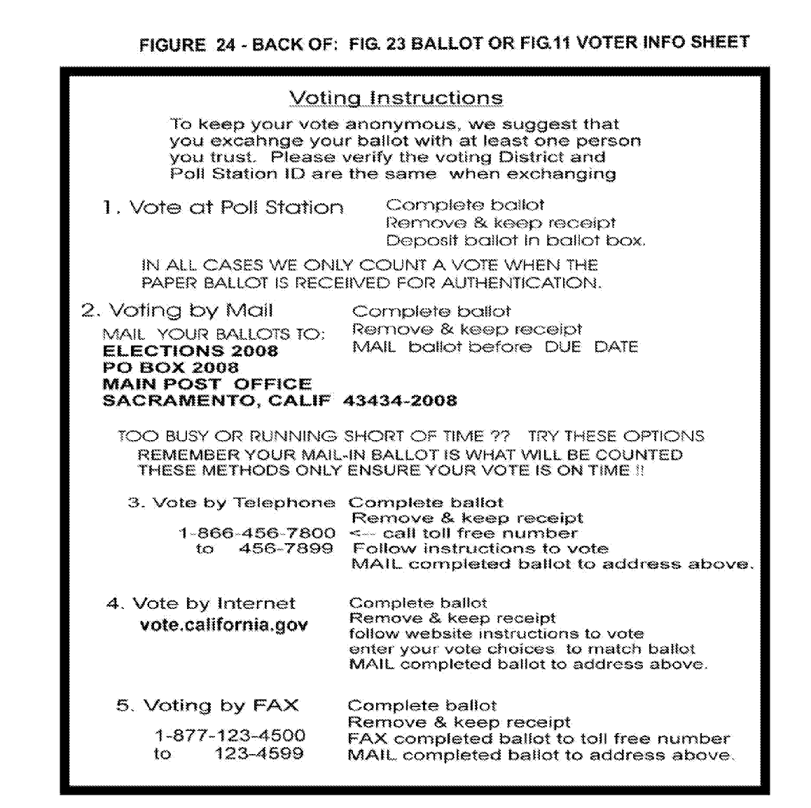

FIG. 23: a site plan view for the FRONT side of an eighth embodiment of a PRIMARY Ballot of the invention, and may be correlated to FIG. 12 of this invention which could then be the BACK side for this FIG. 23, or, alternatively, FIG. 21 or 24 may be correlated to the BACK of FIG. 23.

FIG. 24: a site plan view for the BACK side of a first embodiment of a Voter Instruction Sheet of the invention, and is correlated to FIG. 11, and with further modifications, FIG. 24 may then be correlated to FIGS. 5,9,13,18,19,20,23.

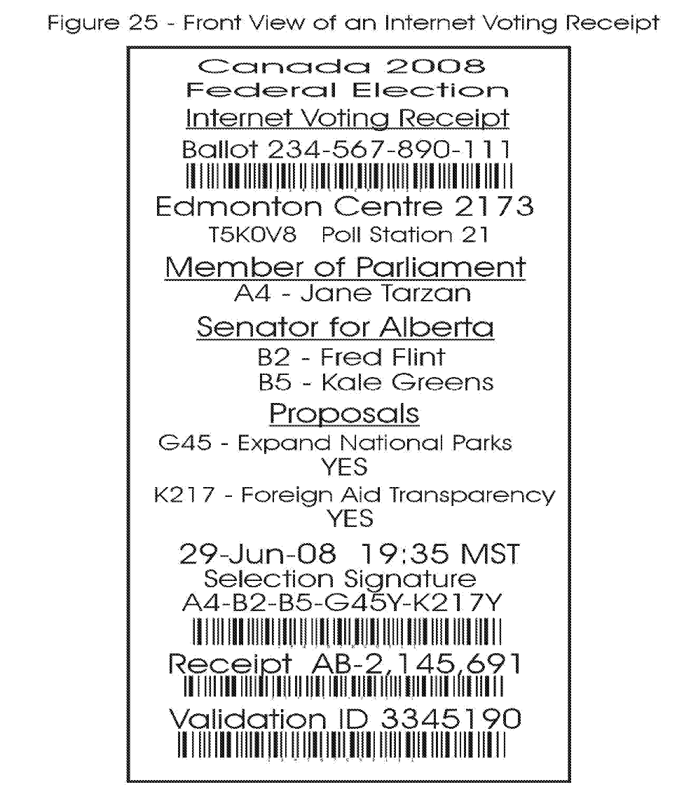

FIG. 25: a site plan view for the FRONT side of a first embodiment of an Internet Voting Receipt of this invention, correlated to FIGS. 5,6,8,9,10,13,18,19,20,23 and with further modifications, may be correlated to FIG. 3,4,12,21,22,24.

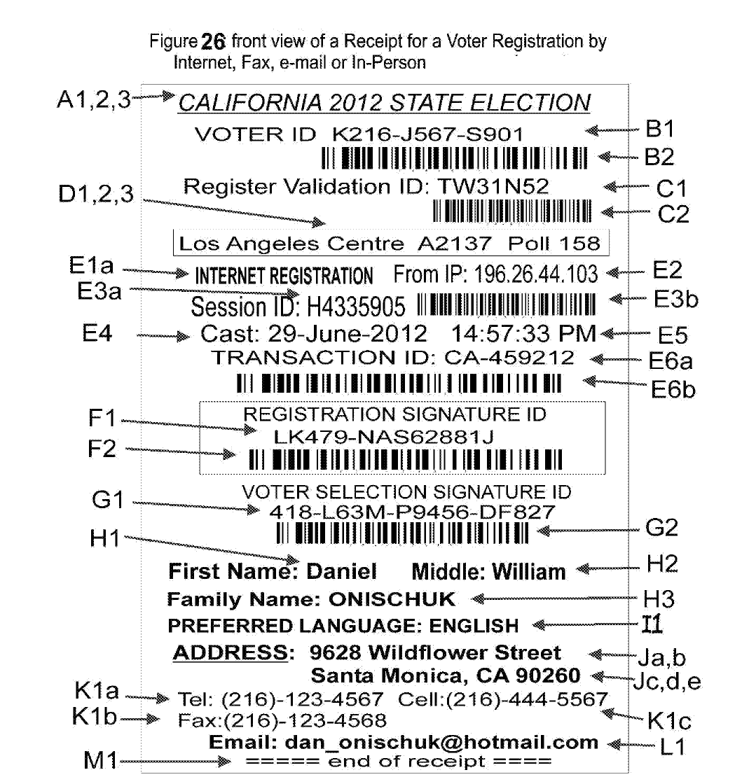

FIG. 26: a site plan view for the FRONT side of a first embodiment of a Receipt for Voter Registration by Internet, Fax, email, or In-Person of the invention.

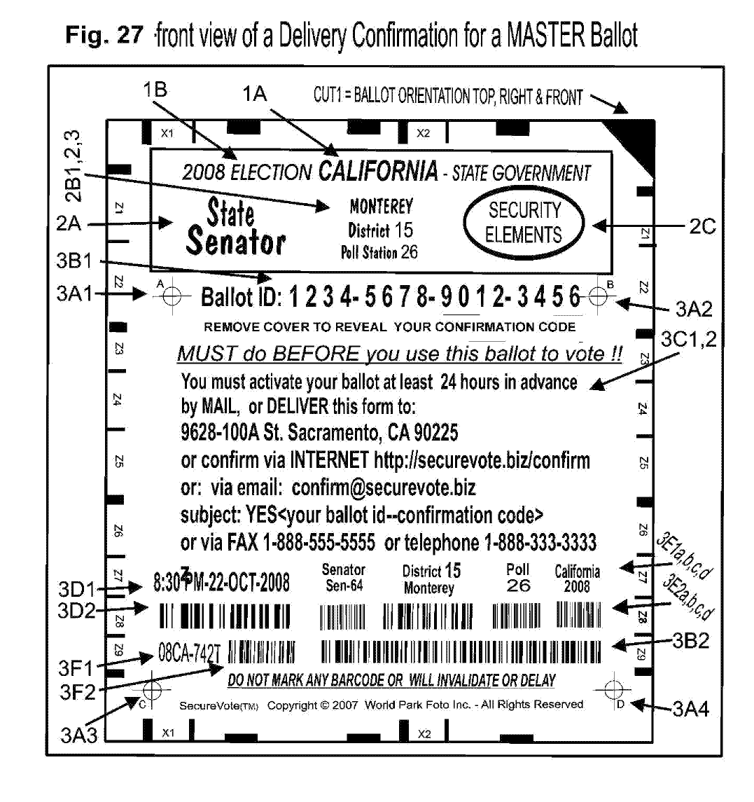

FIG. 27: a site plan view for the FRONT side of a first embodiment of a Delivery Confirmation for a Master Ballot of the invention.

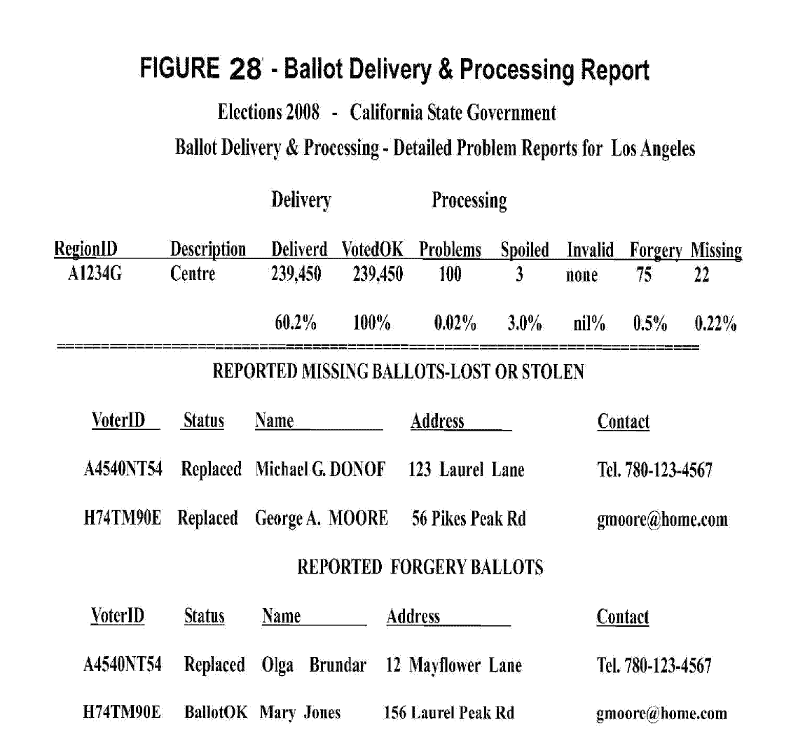

FIG. 28: a site plan view for the FRONT side of a first embodiment of a Ballot Delivery and Processing Report of the invention.

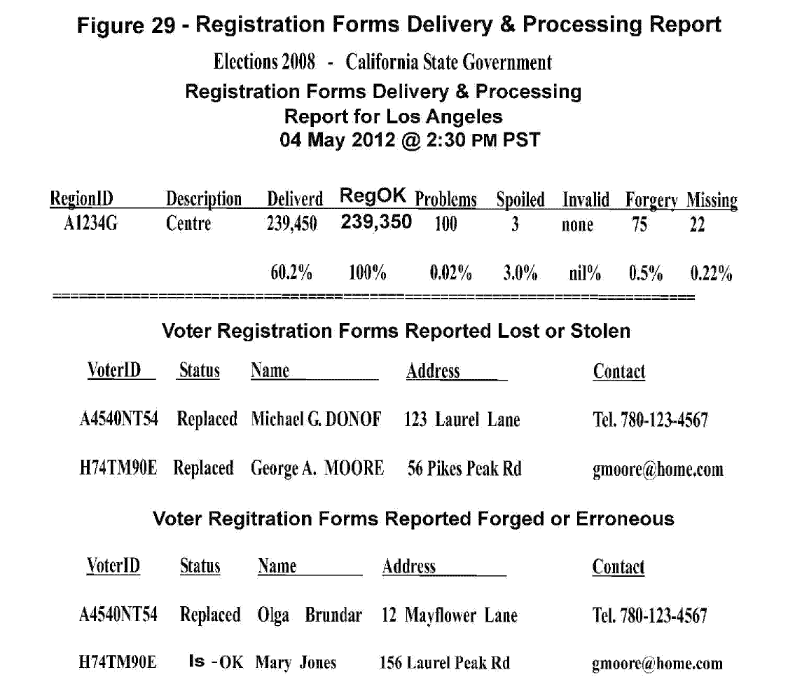

FIG. 29: a site plan view for the FRONT side of a first embodiment of a Voter Registration Forms Delivery and Proccesing Report of the invention.

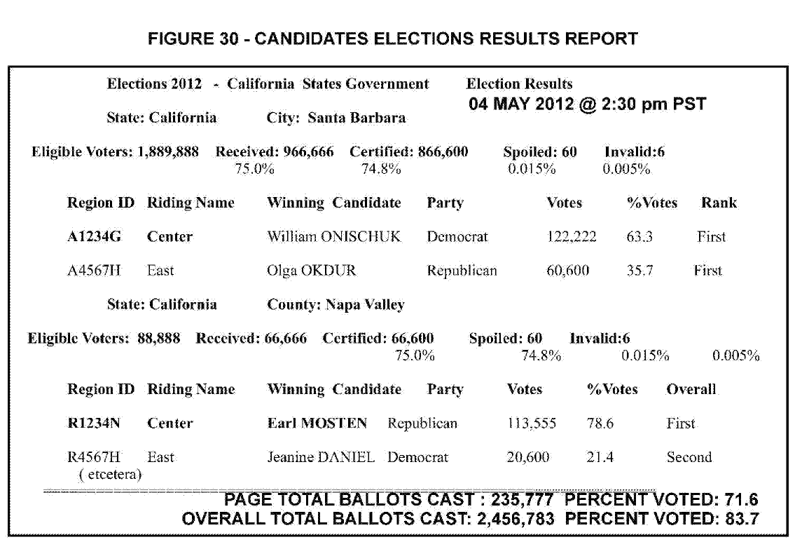

FIG. 30: a site plan view for the FRONT side of a first embodiment of a a Candidates Election Results Report of the invention.

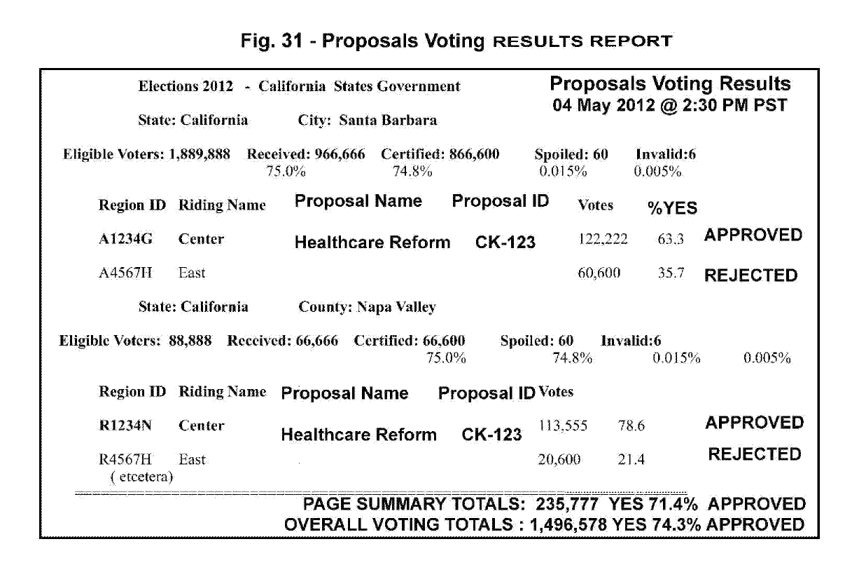

FIG. 31: a site plan view for the FRONT side of a first embodiment of a a Proposals Voting Results Report of the invention.

### DISCLOSURE OF INVENTION

The methods and steps involved in the assembly of a List of Eligible Voters is unique and the first of many improvements to existing patents in this scope of invention.

### A) DEFINITIONS OF TERMS

1) Official, or, Officials—refers to any number and any combination of:
2) persons, devices, computer systems or communication networks appointed by the Hosts of the Voting Session to participate in at least one role or function to facilitate any aspect of the Voting Session;
3) Voter, or, Voters, Eligible Voter, or, Eligible Voters—refers to any number of, persons, or, business entities, or any group of people or business entities, that are, or may be, entitled to participate in the Voting Session for the purpose of select any number of candidates and/or proposals, thereafter delivering their ballots to Officials for authentication and tallying;
4) Voting Session—refers to a process or series of steps and methods for at least one purpose: (i) to select candidate(s), or, (ii) to select to affirm or deny proposal(s), or (iii) any combination of selecting any number of candidates and to affirm or deny any number of proposals;
5) Voting Region is used to describe the Scope of a Voting Session—refer to Entity-Relation Diagrams of FIG. 15. Voting Region may also refer to a variable group of attributes—Province/State, Municipality, Zone, Poll Station, Postal or Zip Code.
6) The attributes are used for data storage, and may also be components of the Voting REGION, depending on the Scope of the Voting Session. Any number of Voting Region attributes may be visible on Ballots, Reports, Calculations, Tallies, Summaries, etcetera as set by Officials to meet Voting Session goals.

### B) DISCLOSURE OF INVENTION

### Details

B) i) an initial assessment is made to define the required tasks and estimate the labor time required to complete the required tasks to complete the Official Voting Session in the time allotted, and to justify the acquisition of materials, devices and people to enable completion of the Voting Session in a timely manner;
B) ii) people, computers, devices, software programs, and communication systems are acquired and developed to complete the tasks of the Official Voting Session;
B) iii) a determination is made for the number of Potential Voters that could participate in the Voting Session, using data from reliable sources (such as census population data, immigration data, social security numbers or tax data for governments, stockholders or employee data for businesses; membership data for groups or professional associations;
B) iv) Officials enquire about remote sources of information that could be used to identify Potential Voters or Eligible Voters, then contact owners of each selected remote data source to obtain agreements, access permissions and methods. A unique source identifier (SID) is assigned to each remote source permission is obtained by, from, or for.
B) v) for a remote source of records to be accepted, it undergoes a preliminary inspection to assess whether it will meet standards for acceptable regarding the relative age of the data, reliability, consistency of data among records, or other quality control methods;
B) vi) remote sources of data that DO NOT pass preliminary inspection requirements are ignored or designated for further investigation at some later time and date; For remote sources of data which DO meet First Inspection requirements:
B) vii) to determine which people or businesses are eligible to vote, Official people, or, Official computers running software programs designed to determine who are Eligible Voters, access computer databases such as those affiliated with sources such as census population data, immigration data, social security and tax data for governments; stockholders or employee data for corporations or businesses; memberships data for groups or organizations, and other information sources (e.g. paper records, microfilm) which contain relevant data about Voters;
B) viii) to accurately determine and keep a verifiable record of which people or business entities are eligible to vote, selected remote source records or parts of remote source records containing data about people or business entities are retrieved by Official people, or, Official computers running software programs;
B) ix) remote source records that contain sufficient data to identify and fulfill the requirements for an Eligible Voter record, are duplicated; and the duplicate copy is verified, then transferred to the record storage facilities and computer data storage systems of the Officials of the Voting Session; furthermore, each of the records transferred is assigned a unique Potential Voter Identifier (PVID), and is marked so as to describe the information as being from a remote source, the remote source identifier (SID), as well as date and time of transfer, and which Officials authorized the transfer and data acceptance.
B) x) remote source records that are missing data are then marked as; Research; Voter for further investigation, and each Research Voter record is assigned a unique identifier (RVID); each Research Voter record is unique in every List of Eligible Voters, and is further unique among all pluralities of Lists of Eligible Voters;
B) xi) Officials assigned to investigate, update, report on each Research Voter record;
B) xii) when each Research Voter record is updated, it is also checked to determine whether it contains sufficient information to satisfy the requirements of data acceptance standards of an Eligible Voter; if so, then it is copied, the original Research Voter record status is marked RESEARCH-ELIGIBLE, the copy record is marked as Eligible Voter, then the copy record is added to the group of Eligible Voter records; and assigned a unique Eligible Voter Identifier (EVID), while also retaining the RVID identifier to so as to enable auditing;
B) xiii) Official people or Official computers running software programs, determine which Research Voter records and which Potential Voter records meet the criteria of the Voting Session to be assigned the designation of Eligible Voter; furthermore, each voter meeting the criteria is designated an Eligible Voter record, and assigned a unique Eligible Voter ID;
B) xiv) Official people or Official computers running software programs, assemble and organize at least one List of Eligible Voters based on Voting Session criteria, comprised of: at least, the names of the voter; and may also include their last known physical address for mail delivery; electronic address or any other method for delivery (such as a private fax machine number, or, forwarding contact address); furthermore, each List of Eligible Voters is assigned an Eligible Voter List Identifier (LEVID); for example, each List of Eligible Voters may be organized by any number of applicable sub-groups of political areas, geographic areas (e.g. electoral boundaries) or people (e.g. citizens of a country, membership dues paid, stockholders having voting shares) for the Voting Session.
B) xv) identical, duplicated records of Eligible Voters found in any one, or existing within several, Lists of Eligible Voters, are removed so that only one instance of a unique Voter remains, so as to prevent multiple ballots delivery to a single voter;
B) xvi) if the rules of the Voting Session, or, any group of people or business entities, or members of a business allow multiple listing of a unique Eligible Voter, then that instance is also an instance or part of this invention; and preceding step B)xv) will be done in another manner so as to accommodate the integrity of the Voting Session, for any group of people or business entities, or any members of a group or business.
B) xvii) Officials publish any number of List(s) of Eligible Voters—using media such as, but not limited to Internet website pages;
B) xviii) Officials advertise the location and methods of accessing each List of Eligible Voters; this step may include sending confirmation notices to each Eligible Voter on each List of Eligible Voters, or, alternatively, placing the onus of responsibility upon eligible voters to remain informed and to take all necessary steps “self-service” to register for voting;
B) xix) Officials provide means and opportunities to all Potential Voters and Eligible Voters to verify or amend each List of Eligible Voters;
B) xx) Officials provide means and opportunities to any subset of any, or, all Potential Voters, Research Voters, and Eligible Voters to contact Officials to amend the List of Eligible Voters—by telephone, Internet, by Mail, email, facsimile (fax) transmission, or in person.
B) xxi) Officials investigate each Potential Voter, Research Voter and Eligible Voter request for amendment and report the findings to Officials and the voter;
B) xxii) Officials amend any number of Lists of Eligible Voters;
B) xxiii) Officials and Voters verifies the amendments are completed accurately;
C) i) Official people or Official computers run software programs to design, and produce any form of specially designed. MASTER Ballots; using the official language of the Voting Session; or language selected by the Eligible Voter;
C) ii) Official people or Official computers run software programs to print or generate any form of representation, of specially designed MASTER Ballots; using the official language of the Voting Session; or, language selected by the Eligible Voter;
C) iii) the number of MASTER Ballots printed or generated is determined by the number of Eligible Voters plus an estimated number to accommodate Lost, Stolen, Damaged, or Spoiled Ballots, and an estimated number of additions to every List of Eligible Voters used for the particular Voting Session;
C) iv) each MASTER Ballot is tested to be both VALID and AUTHENTIC;
C) v) for each MASTER Ballot is passing tests to be AUTHENTIC and VALID according to step C) vi) the further step of designating the Master Ballot, and its constituent parts, to having a Verification Status identifier designated as CERTIFIED;
C) vii) Delivery Status identifier of MASTER Ballots of step 3.e. designated as READY;
C) viii) Activity Status identifier of MASTER Ballots of step 3.f. is set to be DORMANT;
C) ix) the number of MASTER Ballots printed or generated is very carefully controlled, monitored and regulated by Officials of the Voting Session;
C) x) Official people or Official computers run software programs to arrange delivery of any number of MASTER Ballots to each Eligible Voter on every Eligible Voter List;
C) xi) as each MASTER Ballot is processed through the final steps for delivery, the value of the Delivery Status identifier changes from READY to DELIVERED;
C) xii) as each MASTER Ballot is processed through the final steps for delivery, the value of the Activity Status identifier changes from DORMANT to ACTIVE;
D) i) Officials prepare and publish any number of Voter Data Sheets which describes any combination of candidates, proposals, voting session rules, voting instructions, polling station maps, etc. This may also be repeated on the Officials website.
D) ii) Eligible Voters receive at least one MASTER Ballot from Officials or appointees;
D) iii) Eligible Voters receive any number of optional, Voter Data Sheets;
D) iv) Eligible Voters receive any number of PRIMARY Ballot return envelopes;
E) i) Any Eligible Voter or Official may obtain a replacement MASTER ballot in exchange for a DAMAGED or SPOILED ballot that has an Activity Status of ACTIVE;
E) ii) any number of Voters (Applicants) or Officials (Applicants) deliver any number of, and any number of types of MASTER, PRIMARY, RECEIPT Registrations, and/or Ballots submitted IN-PERSON, by MAIL, PHONE, or INTERNET to any number of Officials;
E) iii) Officials receive any number of Registrations and/or Ballots from Applicants;
E) iv) Officials record at least the names and address of each Applicant requesting Ballot Replacement; as well as the date and time of filing the request for replacement; as well as additional identification such as social security number, drivers license number, passport identifier, may also be recorded;
E) iv) a) if the Applicant claims to be an Eligible Voter, Officials search each current List of Eligible Voters for that Voting Session until a determination can be made;
E) iv) b) if the Applicant claims to be an Official of the current Voting Session, other Officials search each List of Officials of the Voting Session for a verification;
E) v) a) Officials accept or reject each received ballot based on the findings of tests applied to confirm the authenticity and validity of each ballot; for example, by verifying Security Element of the Ballot; verifying the Random Symbolic Identifier is Officially valid; verifying Limits of Use; (Recall the Preamble regarding data acquisition, transmission, etc.)
E) v) b) Officials may further accept or reject each received ballot based on the Activity Status attribute of the ballot, whereby the Officials accept ACTIVE ballots;
E) v) c) i) Providing the Applicant, Affidavit, and Ballot submitted are all valid, the ballot receiving Officials cancels the correlated ballots (for example by referring to the Ballot Random Symbolic Identifier), and records the relevant details of each ballot cancellation;
E) v) c) ii) Officials amend all Voting Session records to indicate the ballot Activity Status attribute is designated as CANCELLED for all ballots having the same Random Symbolic Identifier (RSID);
E) v) c) iii) Officials verify the SPOILED or DAMAGED Ballot Activity Status attribute is designated as CANCELLED, on all Voting Session records.
E) v) c) iv) Officials select one MASTER Ballot, designated as a REPLACEMENT Ballot, for each Ballot that was CANCELLED; whereby each REPLACEMENT Ballot is identical to the CANCELLED ballot, except for at least one Random Symbolic Identifier of the REPLACEMENT Ballot being distinctly different from every Random Symbolic Identifier of the CANCELLED Ballot; each REPLACEMENT Ballot is tested to be both VALID and AUTHENTIC; each REPLACEMENT Ballot passing tests of preceding steps has a Verification Status designated as ACTIVE;
E) v) c) v) at least one Official delivering, or arranging the delivery of, a correlated number of REPLACEMENT Ballots to each Applicant; whereupon the Ballot is now designated as a MASTER ballot; furthermore, the Delivery Status attribute of each delivered REPLACEMENT Ballot becomes DELIVERED;
E) v) c) vi) any number of Officials record the quantity and type of REPLACEMENT-MASTER Ballots delivered to every Applicant;
E) v) c) vii) any number of Applicants receive any number of uniquely different REPLACEMENT-MASTER ballots of the same type submitted for replacement;
E) v) c) viii) Any Eligible Voter or Official may obtain a replacement MASTER ballot in exchange for any LOST or STOLEN ballot having an Activity Status of ACTIVE;
E) vi) a) any number of Voters (Applicants) or Officials (Applicants) deliver any number of MASTER, PRIMARY, PHONE, INTERNET Ballots to any number of Officials;
E) vi) b) Officials receive any number of Ballots of the preceding steps;
E) vi) c) Officials record at least the names and address of each Applicant requesting Ballot Replacement; recording the date and time of filing the Affidavit along with additional identification such as social security number, drivers license number;
E) vi) d) any number of Officials provides any number of Applicants with at least one Affidavit form for the purpose of declaring a Ballot to be either LOST, or, STOLEN;
E) vi) e) each Applicant completes the Affidavit of previous step E)Vi)d) whereby:
E) vi) f) each Applicant provides their full legal name with the Affidavit;
E) vi) g) each Applicant provides their address, when applicable, with their Affidavit;
E) vi) h) each Applicant provides at least one form of Voter identification to verify their identity according to the Affidavit;
E) vi) i) each Applicant signs the Affidavit, physically, electronically, or by any other acceptable means according to the Rules of the Voting Session;
E) vi) j) each Applicant delivers, or arranges delivery of their Affidavit to Officials;
E) vi) k) Officials receives any number of Affidavits and identification;
E) vi) l) if the Applicant claims to be an Eligible Voter, Officials determine if the claim is valid by searching every List of Eligible Voters for the Voting Session until a determination is made;
E) vi) m) if the Applicant claims to be an Official of the current Voting Session, other Officials determine whether the Applicant is valid by searching every List of Officials for that Voting Session until a determination can be made;
E) vi) n) Officials may further accept or reject each received ballot based on the Activity Status attribute of the ballot, accepting to tally only ACTIVE ballots;
E) vi) o) any number of Officials, computers, optical or electronic devices, or humans accepts or rejects all other information provided for each Applicant, Affidavit or Ballot; (Recal; Preamble—data acquisition, transmission, etc.)
E) vi) p) for each valid Applicant whose Affidavit that has been sufficiently verified, at least one Official amends the Voting Session computer records to CANCEL each LOST or STOLEN Ballot that was previously delivered to the Applicant;
E) vi) q) at least one Official verifies that each LOST or STOLEN Ballot according to the preceding steps, is designated as CANCELLED on all Voting Session records; and the Activity Status attribute for each CANCELLED ballot record is set to CANCELLED;
E) vi) r) at least one Official replaces or arranges to replace each LOST or STOLEN ballot, comprising of at least the steps whereby: 5.b.11.a. selecting one MASTER Ballot designated as a REPLACEMENT Ballot for each Ballot that was CANCELLED; 5.b.11.b. each REPLACEMENT Ballot is identical to the CANCELLED ballot, except for at least one Random Symbolic Identifier of the REPLACEMENT Ballot being different from every Random Symbolic Identifier of the CANCELLED Ballot; each REPLACEMENT Ballot of claim is tested to be both VALID and AUTHENTIC; each REPLACEMENT Ballot passing tests has a Verification Status designated as CERTIFIED; the REPLACEMENT Ballot of Activity status is set to ACTIVE;
E) vi) s) for each verified Applicant whose Affidavit was also verified, at least one Official delivers, or arranges for the delivery of, at least one, REPLACEMENT Ballot to the Applicant that completed the Affidavit;
E) vi) t) at least one Official delivers, or arranges the delivery of, any number of REPLACEMENT Ballots; whereupon delivery, the Ballot is now designated as a MASTER ballot; and the Delivery Status attribute of each delivered REPLACEMENT Ballot is now DELIVERED; E) vi) u) any number of Officials record the quantity and type of REPLACEMENT-MASTER Ballots delivered to every Applicant;
E) vi) v) any number of Applicants receive any number of unique, different REPLACEMENT-MASTER ballots of the same type submitted for replacement;
F) MASTER Ballot Exchange—this method is unique among registered US patents, and provides a significant improvement in the arts pertinent to this invention.
F) a) Eligible Voters are entitled to exchange with someone they trust, any number of MASTER Ballots they possess for identical MASTER ballots that are authentic and valid for use as per the Limits of Use. Voters can authenticate the ballot in person, by telephone or Internet by verifying the Random Symbolic Identifier. Security Elements may also be used to determine whether the ballot is a forgery.
F) b) To protect privacy, Voters are instructed to swap the ballot the Voter received, at least once, with someone they trust for a similar ballot that is valid within the geographic-political boundary of the Voting Session. This random, private ballot exchange decouples the Ballot recipient from the Eligible Voter List that was used to deliver the unique BALLOT VOTING RSID to a specific person and address. This can be done many times to increase the anonymity of the Voter. The privacy of the Voter is still enabled even if a Voter does not exchange MASTER Ballots, as the Voting Session Officials likely have no easy method to determine whether or not any MASTER Ballot was exchanged before being returned to them for tallying. Thus, Voter privacy is assured.
G) a) Each MASTER Ballot has two parts—a PRIMARY Ballot and at least one RECEIPT Ballot (refer Entity Relation Diagram describing Master Ballot and constituent parts)
G) b) Each MASTER, PRIMARY and RECEIPT Ballot has at least one status attribute each attribute remains static in value until redefined by Officials;
G) c) The paper version of a MASTER, PRIMARY, or RECEIPT Ballot shall include any number of alignment marks and indices for orientation of optical, magnetic, electronic scanning device(s) so as to facilitate the accurate scanning of data on any reasonable ballot.
G) d) Each part of the MASTER Ballot, both the PRIMARY Ballot and any number of RECEIPT Ballots, share an identical, unique group of symbols as a correlating identifier. A unique feature of this invention is a Random Symbolic Identifier (RSID) as being the recommended unique correlating identifier, discussed in following sections of H)e)1) to H)e)4), H)f) to H)h).
G) e) the second ballot part of the MASTER Ballot is referred to as a RECEIPT Ballot; a unique feature of this invention is that each RECEIPT Ballot is manufactured so as to be easily and readily distinguishable from the PRIMARY Ballot, to the unaided human eye using any combination of methods and drawings described herein so as to readily distinguish the RECEIPT Ballot from the correlated PRIMARY Ballot;
H) a) To understand the PRIMARY Ballot part of the Master Ballot referred to in G) a), G) b) (refer to plan for the FRONT side of a first embodiment of Primary Ballot of the invention). H) b) ballot header portion—this portion improves the invention of Kargel by providing information to enable the voter to independently make clearly informed decisions regarding the ballot by providing information to the voter: as to the source of the ballot (FIG. 5 item 1A—ballot source); defining the scope of the ballot application (FIG. 5 item 1B—ballot purpose); clearly identifying the type of ballot (FIG. 5 item 1C—ballot type); instruction as to what to do with the completed ballot (FIG. 5 item 1D—ballot destination instruction). H) c) voting portion—this portion improves the invention of Kargel by providing vital information to enable the voter to independently make clearly informed decisions regarding the ballot selection options by providing specific information as to the title of political position (FIG. 5 item 2A—candidate position description); specific instructions as to how many candidates to select (FIG. 5 item 2C—voting instructions); and information as to how to properly select the candidates of choice (FIG. 5 item 2D—candidate selection methods); as well as specific descriptions of the candidates to significantly reduce selection errors (FIG. 5 item 2E1—candidate names) and an optional description of the candidate political party affiliation (FIG. 5—item 2E2) and the correlated Candidates Selection Area (FIG. 5, Item 2E3) is for marking to select any number of candidate(s).
H) d) Ballot ID portion—this portion is unique among registered patents, providing significant improvements in the arts of invention by this invention.
H) e) Although this invention was conceived without knowledge of Kargel's invention, there is a common thread whereby each MASTER ballot, and the constituent parts comprising the PRIMARY Ballot, and any number of RECEIPT Ballots, share an identical, identifier. However, Kargel does not specify any characteristics of his identifier, nor its method of assembly, and only a few details of implementation;
H) e) 1) This invention improves significantly on Kargel by the use of a Random, Symbolic Identification (FIG. 5 item 3B1—Ballot ID in the form of a Random Symbolic Identifier). The Random Symbolic Identifier (RSID) is comprised of a group of randomly selected symbols, which are arranged in a combination that is unique among all RSID's of a Voting Session. Thus each PRIMARY and RECEIPT Ballots that comprise a Master Ballot are uniquely identifiable among all ballots (and is also unique among all Voter Registration Forms) of a Voting Session.
H) e) 2) The RSID of FIG. 5—item 3B1 is encoded and correlated to a unique barcode FIG. 5—item 3B2 so as to facilitate rapid, automated optical scanning.
H) e) 3) A unique aspect and benefit of this invention is that the RSID is a random identifier which prevents anyone with any ballot from fabricating a series of ballots, by incrementing or decrementing values in reference to any known ballot identifier.
H) e) 4) This invention shall also include the provision to include a sequential series of symbols, or a repeatable pattern of symbols, should the Officials of the Voting Session desire such a feature. It should be noted that an implementation of either would require corresponding adjustment to this invention, including the understanding that the term RSID would imply either a sequence or pattern for this invention document; It is beyond the scope of this document to speculate at all the possible combinations of symbol sequences or patterns may created for either potential request.
H) e) 5) Furthermore, this invention shall also include the methods whereby no group of unique symbols are assigned to uniquely identify any ballot—authentication thereby relies primarily upon the Security Elements of the Ballot. The steps of research, computerized data mining of Eligible Voters, mailing ballots, exchanging ballots, and any parts of this invention would include any “no ballot id” version of this invention.
H) e) 6) This document considers use of the RSID of steps H)e)1) to H)e)4), with the implied claims to include other Ballot ID methods that may be applied instead (such as, but not limited to: sequential symbols/numbers in lieu of RSID(s)).
H) f) A very significant improvement of this invention is to make the RSID of steps H)e)1) to H)e)4) to be extremely difficult to guess. The purposes of the RSID is to enable verification by computer of the ballot identity as an authentication test of validity and to prevent counterfeiting of a multitude of ballots. Using at least one, and possibly two, or more, concatenated symbolic characters as a Random Symbolic ID (RSID) would provide unique identity security of every single ballot (depending on the number of ballots issued) for a single Voting Session. To understand how this is so, consider that ONE symbolic character can be represented by a unique combination of a sequence of eight (or more) computer binary digits ranging from 00000000 to 11111111. Each sequence of binary digits has a Base 10 counting system numeric equivalent value.

| ASCII characters | Binary code | Base 10 value |
|---|---|---|
| A | 01000001 | 65 |
| B | 01000010 | 66 |

Concatenating characters increases the number of binary digits that can be interpreted to represent larger binary and numeric (base 10) numbers, as well as for a plurality of counting base methods such as base 8 (octal), base 16, etcetera.

| ASCII characters | Binary code | Base 10 value |
|---|---|---|
| BA | 01000010 01000001 | 16961 |
| AB | 01000001 01000010 | 16706 |

Each unique concatenation is a unique combination of symbolic characters. The positional ordering sequence of the concatenated symbolic characters has a unique binary value and a correspondingly unique, equivalent numeric value that can be used to identify a specific sequence of concatenated symbolic characters.
Therefore each and every unique concatenation of symbolic characters also has a unique numeric value associated only with that specific combination of symbolic characters when using a consistent method of assigning each character symbol to only one binary value. (Note: 1x10E3=1,000 1x10E4=10,000 the maximum value of the most significant digit of the binary number is calculated by 2EX where X=number of binary digits.)

| ASCII | | Binary | | Total “N” | 2 exp “N” = |
|---|---|---|---|---|---|
| Characters | | Digits | | Binary Digits | Maximum Value |
| 8 | × | 8 | = | 64 | 1.8 × 10E19 |
| 16 | × | 8 | = | 128 | 3 × 10E38 |
| 24 | × | 8 | = | 192 | 6 × 10E57 |
| 32 | × | 8 | = | 256 | 1 × 10E77 |

To understand how large these numbers are, consider that the Planet Earth has about 3.6x10E51 atoms; the entire Universe about 10E78 to 10E81 atoms. reference note 1—http://mathforum.org/library/drmath/view/59178.html How effective is a 16 character (128 binary digits) RSID (3x10E38) for voters ? If we divided RSIDs among the entire human population of Earth: 7,000,000,000 3x10E38/7x10E9=4.2 8x10E28=42,800,000,000,000,000,000,000,000,000 unique RSID combinations available to EACH person on Earth. Guess which ONE their Ballot was given! A super-computer capable of 4.28x10E12 guesses per second=4.28x10E28/4.28x10E12=1x10E16 seconds/(365 days×24 hours×3600 seconds)=317×10E6=317,000,000 YEARS to enumerate/guess each RSID available to ONE Ballot for ONE person on Earth!

The actual number of symbols to use for this invention must be calculated, based on the number of voters anticipated, perception of security desired for making the RSID extremely difficult to guess, balanced with the data storage needs, scanning error rate, computer processing error rate and extra communication required for having a large number of symbols comprising each RSID; while also taking into consideration the total number of ballots issued, anticipated number of enquiries, replacements, verifications, authentications, amendments, publications, etc.

This inventions unique application of these mathematical facts and estimates are such that any attempts to counterfeit any Ballots are futile, as without a valid RSID, a ballot is rejected by the Voting Session computers. There is no point trying to fake multiple copies of a known PRIMARY BALLOT VOTING RSID, as only one RSID is considered in the vote records and tallies. When two or more ballots having an identical RSID are detected, the ballots prior and subsequent votes are nullified, then all ballots with the identical RSID are extracted and processed electronically and/or manually to inspect each Ballot composition and Security Elements for Authentication and Validation to certify which ONE ballot to tally for a Vote.

Therefore it is also absolutely vital that any and all valid VOTING RSID's created by the Voting Session Officials be kept absolutely secret before and during the voting session such that only the person casting their Primary Ballot should know the VOTING RISD being used.
H) g) To further reduce errors in computer ballot processing a warning is included (FIG. 5—ballot processing warning), to reduce the amount of manual processing.
H) h) To further reduce and detect errors, the RSID symbols are also scanned and compared to the RSID derived from the correlated barcode of H)e)2) for corroboration of the RSID.
H) i) Security Elements portion—This is another unique feature of this invention with respect to other inventions of the scope of this art. This feature is a vital feature to ensure the integrity of the ballot, in order to guarantee the final vote tallies are not unfairly influenced by the creation of fictitious voters. Security Elements (FIG. 5 item 3A) are designed to assist with authentication of any Ballot, whereby the Security Elements are comprised of any number of components such as, but not limited to: Random Symbolic Identifier codes of steps H)e) to H)h), sequential symbolic identifiers, grouped symbolic identifiers, physical characteristics or devices, optical characteristics, structures or devices, electronic characteristics, devices or structures, magnetic characteristics, fields or devices, organic or inorganic chemicals, biological materials, genetic materials or genetic structures or genetic sequences, special materials, crystal structures, plastics, metals, gas emissions, electromagnetic radiation, radioactive materials, optical emissions, natural fibers, man-made fibers, microfilm dots, microscopic writing, embossing, impressions, watermarks, seals of authenticity, and any other physical structures, or any other properties, affixed or associated with any ballot; and the additional options for decoding-encoding elements of the VOTING RSID to be coordinates to the elements within any number of n-dimensional matrices to provide additional data correlation-comparisons for security-authentication;

### H) j) Limits of Use Portion

The variety of Voting Sessions possible requires that this section of the Ballot be considered as a variable data area. The Limits of Use area of the Ballot contains several data fields, whereby any single data field may be displaying any number of any data fields, in any number of combinations of data fields, having correlated data for each data field logically inter-related to each other and furthermore defining the correlation for each distinct group of ballots, using correlated information derived from various sources of information.
The Limits of Use area may also be considered a generic “data container” when using methods of marking, identification, encapsulating or otherwise hiding ballot internal details (eg such as, but not limited to RSID) when implementing printing, distributing, receiving, sorting, validating, tallying, certifying, error detecting, error correcting of any number of master ballots, master voter registrations, any other documents and respective components.
Voting Region sub-portion of the Limits of Use portion is used to describe the Scope of a Voting Session sub-portion of the Limits of Use portion (refer FIG. 15).
Voting Region also refers to a variable group of attributes—Province or State, Municipality, Zone, Poll Station, Postal or Zip Code. The groups of Voting Region attributes are used for data storage, and may also be components of the Voting Region, depending on the Scope of the Voting Session. Any number of Voting Region attributes may be visible on Ballots, Reports, Calculations, Tallies, Summaries, etcetera as determined by Officials to meet the needs of a particular Voting Session. (Refer FIGS. 5, 6, 8, 9, 10, 12, 13, 18, 19, 20, 23, 25).
H) j) 1) the Voting Region identifier (FIG. 5—item 3E1b,c,d—RegionID) sub-portion of the Limits of Use portion is a unique identifier or group of identifiers used to further define the scope of application of the ballot such that it is correlated to (but not limited to) a geographic area, or, a subset of a group of people or legally recognized entities, etcetera; FIG. 5—items 3E2b,c,d are barcodes correlated to the value of FIG. 5—items 3E1b,c,d.
H) j) 2) Referring to FIGS. 5—item 3E1b,c,d forms a Voting Region Name Description for ease of human interpretation to facilitate ballot exchanges and other human processing; and 3E2b,c,d are correlated barcodes to facilitate electronic-optical machine processing. Refer to FIG. 5—item 3E1b1 is the Zone Identifier Number; item 3E1b2 is a Zone Name Description for item 3E1b1; item 3E2b1 is a barcode for items 3E1b1 and/or 3E1b2;
H) j) 3) Refer to FIG. 5—Item 3E1c1 is a Polling Station identifier, an attribute (component) of the Voting Region identifier, used to organize Ballots and facilitate analysis. Item 3E1c2 is a barcode correlated to the value of item 3E1c1.
H) j) 4) Refer to FIG. 5—item 3E1d1 is a Province-State attribute of the Voting Region, item 3E1d2 is a Date component of the Voting Session; item 3E2d2 is a barcode correlated to the value of the concatenated items 3E1d1 and 3E1d2. Item 3E1d1 & 3E1d2 may also be considered as the Voting Session Host Identifier (VSHID) used to uniquely identify, distinguish & organize a variety of ballots per Voting Session and/or past or future sessions.
H) j) 5) an optional item is a Postal-Zip Code identifier, an attribute (or component) of the Voting Region and of the ZONE ID to facilitate analysis of voter responses. Postal-ZipCode Identifier may also have a barcode correlated to description values.
H) j) 6) Refer to FIG. 5, item 3E1a is a Title of the Elected regarding the purpose of the ballot being a Candidate Election to fulfill the elected Duty. Item 3E1a2 is the abbreviation e symbols for the UNIQUE code associated to the Political Duty, which may be used for election accounting of ballots, or verification for ballot exchange, other ballot processing, or ballot cost accounting. Item 3E1a3 is a barcode correlated to the value of item 3E1a2.
H) j) 7) Refer to FIG. 5—item 3D1a,b refers to Ballot Delivery Due Time and Due Date identifiers—Delivery Due Date (item 3D1a) and Delivery Due Time (item 3D1b) describes the latest date and time the ballot is required to be delivered to the designated receiver(s) of the Voting Session, in order for the Ballot to be considered for any Official processing. Item 3D2 is a barcode with value correlated to concatenated or numeric value(s) of 3D1a,b.
H) j) 8) So far descriptions have looked at the constituent components of various types of ballots which have general groupings, such as, but not limited to: whereby FIGS. 5, 19 are examples of “Candidate Ballots”; whereby FIG. 20 is an example of a “Proposal Ballot”; FIG. 13, 18, 23 comprised of Candidates and Proposals (“Hybrid” or “Hybrid” Ballot).
H) j)9) In the case of a Proposal Ballot (FIG. 20), any number of proposals are presented and each are given AT MOST ONE unique identifier that is correlated to the ONE correlated proposal, and further correlated to the sub-portion allocated to record the voters choice(s).
Each proposal unique identifier (PID) may also be assigned any number of barcodes correlated to the value of the associated PID, and/or to any number of the value(s) of the voter choice(s) available.

### H) j) 10) FIG. 13,18,23—Hybrid Ballot of Candidates and Proposals (“Hybrid” Ballot);

H) j) 11) Refer to FIGS. 13,18 “Vote Region”—to reduce human error when exchanging or processing ballots, an alternative is the use of an integrated Region-Poll Identifier that identifies any number of sub-regions within a Zone or Region ID; whereby the Region Name description eases human interpretation, and each single barcode or group of barcodes is correlated to values of (but not limited to): Region ID, Poll Station ID.
H) k) To further reduce and detect errors, the identifier symbols of any descriptive human readable text of any ballot, form or document fields may also be scanned at the same time and compared to values of the respective scanned barcode(s) values for corroboration—and the additional options for decoding-encoding and evaluating the aforementioned identifier symbols to the data contained by the elements within any number of n-dimensional matrices of the correlated VOTING RSID via associated decoded-encoded coordinates referred to in H)i);
H)j) As the steps, means methods and processes described involve people and devices that are not perfect in design, function or operation, all aspects of this invention shall also include, but not otherwise be limited to:
1) All methods within the broad scope of data processing tasks may be applied to this invention; in particular this invention includes the means and methods of acquiring data from any remote or local data source, or any ballots of any type that conforms to the specifications of the Voting Session;
2) The steps of locating, detecting, reading, receiving, interpreting, translating, correcting, and transmitting any number of, and any combination of: symbolic codes, physical characteristics, physical structures, optical structures, optical devices, electronic devices, electronic structures, magnetic fields, magnetic devices, organic chemicals, inorganic chemicals, biological materials, genetic materials or genetic structures or genetic sequences, special materials, crystal structures, plastics, metals, gas emissions, electromagnetic radiation, radioactive materials, optical emissions, natural fibers, natural or synthetic fibers, microfilm dots, microscopic writing and any other physical structures associated directly with a ballot or a plurality of Master Ballots, Primary Ballots, Receipt Ballots, Voter Registration Forms, or Voter Registration Receipts or any related documents;
3) the tasks of locating, reading, receiving, detecting, translating, correcting, interpreting and transmitting are performed by any combination of:

a) at least one Official person;

b) any number of data acquisition devices;

c) any number of electronic, optical or biological computing devices;

d) any number of communication networks;

e) any number of other man-made device or plurality of devices;

f) the methods of transmitting data to, and receiving data from, any number of humans, computers, devices, telephones, the Internet or any other communications networks; including the methods of translating human and device readable codes to any number of methods, modes, protocols, data communications and data-signal transmissions and data-signal receptions;
g) the methods of locating, receiving, detecting, interpreting, translating, reporting, and transmitting error free data, and the further steps of locating, receiving, detecting, interpreting, translating, reporting transmitting, and correcting compromised data, erroneous data, duplicate data or duplicate data-signal transmissions and/or data-signal receptions;
h) any steps, means, methods and processes of monitoring, acquiring, detecting, receiving, transmitting, acknowledgement, confirmation, verifying or correcting of any compromises, errors, duplicate data; and furthermore, any steps, means, methods and processes of monitoring, acquiring, detecting, receiving, transmitting, verifying effects of any corrections or other actions taken;
4) the steps and methods further described in the claims of this invention;

What is claimed is:

1. The steps and methods of Officials conducting a Voting Session, according to claims 1 to 19, whereby any number of Officials use the steps and methods of claim 9 to identify, research and assign any number of people or other legal entities to, at most, one type of Voters List (such as, but not limited to—Eligible Voters List, Proxy Voters List, Potential Voters List, or Ineligible Voters List); and the further step whereby each Eligible Voter, Proxy Voter, Potential Voter, or, Ineligible Voter is assigned one unique identification symbol or groups of symbols known as a Master Voter ID (MVID) to distinguish each person or legal entity from other voters or legal entities on the same Voters List or any other Voters List of this invention; and the further step whereby each type of Voters List is assigned a unique symbol or group of symbols to distinguish it from other types of Voter Lists; and the further steps and methods of any number of Officials creating any number of duplicate copies of any number of each type of Voters Lists, and the further steps and methods of Officials processing any number of Voters Lists using the steps and methods of (but not limited to) claim 9; and the further steps and methods whereby each Voter is assigned a Master Voter Identifier (MVID) that is unique among all Voters and is also unique among all Voter Lists of the applicable Voting Session.

2. The further steps and methods of conducting a Voting Session according to claims 1 to 19, whereby any number of Officials correlate any number of unique Master Voter Identifiers (MVID's) of claims 1 and any number of Voters Lists of claim 1 to any number of Master Voter Registration Forms of this claim, whereby each Master Voter Registration form is comprised of two parts, whereby one part is a Primary Voter Registration form (FIG. 1) and the second part is comprised of any number of Receipt Voter Registration Forms (FIG. 2), such that each Primary and Receipt parts of each Master Voter Registration is assigned at least one unique identifier known as a Voter Registration ID (VRID) to distinguish each Master Voter Registration form (and its constituent parts) from all other Master Voter Registrations forms (and their constituent parts), and furthermore that for each Master Voter Registration form, the component Primary Voter Registration form and all Receipt Voter Registration forms for the same Master Voter Registration form), contain identical Voter Registration information and are correlated to each other by sharing the same unique VRID identifier that is printed, embedded or linked to each part of the Master Voter Registration form; and the further steps and methods whereby each Master Voter Registration form (and each Primary and Receipt part) is comprised of (but not limited to)—at least one portion containing elements of voting information (such as, but not limited to—voting session name, voting session type, Voter Registration ID (VRID), assigned Voter Address identifier (VAID)) whereby each element of voting information is correlated to any number of scanning codes (such as but not limited to barcodes), and the further steps of assigning at least one portion for recording voter identification, at least one portion for recording the voters legal name, any number of portions for recording the voters signature, at least one portion for recording the date of Registration form completion; and the further steps and methods whereby each Receipt Registration form is manufactured so as to be easily distinguishable from the Primary Registration form using any combination of—additional word markings such as but not limited to the word RECEIPT, raised symbols (such as, but not limited to Braille codes), any number of different colors, different texture, or different materials, different physical, electronic, electromagnetic, or optical representation, or any other form of representation that differs from that which is used to manufacture the PRIMARY Registration form, which may include (but not limited to) creating, assigning, linking, attaching, embedding or any other steps and methods of (but not limited to) claim 9, for any number of, and, any combination of (but limited to)—symbolic codes (such as but not limited to RSIDs), physical characteristics, physical structures, optical structures, optical devices, electronic devices, electronic structures, magnetic fields, magnetic devices, organic chemicals, inorganic chemicals, biological materials, genetic materials or genetic structures or genetic sequences, special materials, crystal structures, plastics, metals, gas emissions, electromagnetic radiation, radioactive materials, optical emissions, natural fibers, natural or synthetic fibers, microfilm dots, microscopic writing, embossing or any other physical structures associated uniquely and directly with the RECEIPT Registration form so as to distinguish each RECEIPT Registration form from every PRIMARY Registration forms; and the steps and methods of printing, assigning, linking, correlating or embedding any number of Security Elements of claim 6 (such as, but not limited to RSID, holograms) for each Registration Form (Master, Primary, or Receipt); and the further steps and methods for each Registration form of allocating identical portions for Voters or Officials to mark and record information comprising of, but not limited to—any number of personal identifiers, any number of printed names, any number of signatures, any number of date information, any number of location information; and the further steps and methods for each printed Master Voter Registration Forms of printing, attaching or embedding, any number of optical scanning markings, alignment markings or skew markings to ensure proper optical scanning, and the further steps and methods of consistently shaping, or cutting away, or marking at least one corner of each Master Voter Registration Form (and each Primary Voter Registration Forms and each Receipt Voter Registration Forms) so as to identify a consistent orientation (such as, but not limited to: front face in view and top edge uppermost) to assist in sorting, organizing, scanning, counting and any other human, mechanical, optical, electronic or hybrid processing or other processing according to claim 9 of any number of Voter Registration Forms (Master, Primary or Receipt) and any number of Voter Registration Containers; and the further steps and methods for each electronic Voter Registration forms (Master, Primary and Receipt) of processing according to (but not limited to) claim 9 to ensure data record quality requirements such as, but not limited to: accuracy, integrity, security and longevity; and the further steps and methods of applying the steps and methods of this claim to any number of other items such as, but not limited to: forms, documents, ballots containers, in any format (such as but not limited to: electronic file, or, printed on paper), such as, but not limited to Master Voter Language Forms and the constituent components, such that, but not limited to: whereby any number of Officials correlate any number of unique Master Voter Identifiers (MVID's) and any number of Voters Lists of claim 1 to any number of Master. Voter Language forms of this claim, or, any number of Master Voter Registrations of claim 2 to any number of Master Voter Language Forms of this claim; and the further steps and methods of processing according to claim 9, any number of Master Voter Language forms, any number of Primary Voter Language forms, any number of Receipt Voter Language forms, whereby each Master Voter Language form is comprised of two parts, whereby one part is a Primary Voter Language form (FIG. 3) and the second part is comprised of any number of Receipt Voter Language forms FIG. 4), such that each Primary and Receipt parts of each Master Voter Language form is assigned at least one unique identifier known as the Voter Language ID (VLID) to distinguish the Master Voter Language forms (and its constituent parts) from all other Master Voter Language forms (and their constituent parts), and furthermore that for each Master Voter Language form, the component Primary Voter Language form and all Receipt Voter Language forms (for the same Master Voter Language form), are nearly identical and are correlated to each other by sharing the same unique MLID identifier that is printed, embedded or linked to each part of the Master Voter Language form; the steps and methods of printing, assigning, linking, correlating or embedding any number of Security Elements of claim 6 (such as, but not limited to RSID, holograms) for each Language form (Master, Primary, or Receipt); and the further steps whereby at least one portion containing elements of voting information, correlated to any number of barcodes or other optical scanning markings, at least one portion containing additional information, and the further steps and methods whereby each Receipt Language form is manufactured so as to be easily distinguishable from the Primary Language form using any combination of—additional word markings such as but not limited to the word RECEIPT, raised symbols (such as, but not limited to Braille codes), any number of different colors, different texture, or different materials, different physical, electronic, electromagnetic, or optical representation, or any other form of representation that differs from that which is used to manufacture the PRIMARY Language form, which may include linking, attaching or embedding any number and combination of (but not limited to)—Security Elements of claim 6, and any number of other steps, methods, properties, materials or representational forms described in claim 2 that are used to differentiate Primary Registrations from Receipt Registrations shall also be applicable to RECEIPT Language Forms so as to distinguish each RECEIPT Language Form from every PRIMARY Language Forms; and the further steps and methods of this claim that were attributed to Voter Registrations to be applied for each Language Form, any other object such as, but not limited to documents, forms, reports, containers, electronic files, physical objects; and (d) the further steps and methods for the any version of any number of MASTER, PRIMARY, or RECEIPT Ballots whereby any each shall include any number of but not limited to: alignment marks, graphics, electronic encoding, magnetic fields, and/or any form of index identifiers for orientation of optical, magnetic, electronic scanning device(s) so as to facilitate the accurate scanning of data on any ballot in reasonable condition; and (e) the further steps and methods for printed ballots of including such as, but not limited to) a darkened, highlighted or cut-away corner so as to enable identical orientation of ballots for faster preparation for scanning (such as but not limited to FIG. 5—cut 1); whereby any number of (but not limited to) the aforementioned steps and methods are used so as to enable rapid automated optical scanning using high speed scanning devices, computers, using the steps and methods according to (but not limited to) claim 9 of this invention; and the further steps and methods whereby the aforementioned steps and methods of this claim may be applied any number of times, to any number of other items of this invention, such as, but not limited to: Voter Information Sheets, Master Ballots and constituent parts.

3. The steps and methods of conducting a Voting Session according to claims 1 to 19 whereby any number of Officials correlate any number of unique Master Voter Identifiers (MVID's) and any number of Voters Lists of claim 1 to any number of Master Voter Ballots of this claim, or, any number of Master Voter Registrations of claim 2 to any number of Master Voter Ballots of this claim; and the further steps and methods of claim 9 for the steps and methods of, but not limited to: defining, designing, verifying, correlating, amending, certifying, preparing, organizing, sorting, assembling, recording, storing, printing, distributing, receiving, scanning, correlating, validating, authenticating, publishing and otherwise processing any number of Master Ballots, any number of Primary Ballots, any number of Receipt Ballots, whereby each Master Ballot is comprised of parts, whereby one part is the Primary Ballot (FIG. 5,7,9, etc.) and any other parts are comprised of at least one Receipt Ballot (FIG. 6,8,10), such that each Primary and Receipt parts of each Master Ballot are assigned least one unique Ballot Random Symbolic Identifier (BALLOT VOTING RSID), which is prominently visible on the Master Ballot (and component Primary and Receipt parts) so as to distinguish that Master Ballot (and all of its component parts) from all other Master Ballots (and their component parts) and furthermore that for each Master Ballot component Primary Ballot and all of the Receipt Ballots of the same Master Ballot are correlated to each other by sharing the same unique BALLOT VOTING RSID identifier that is printed, embedded or linked or otherwise displayed prominently on each Primary Ballot and Receipt Ballot part of the Master Ballot such that each Receipt Ballot is manufactured so as to be easily distinguishable from the Primary Ballot to the using any combination of—additional word markings (such as but not limited to the word RECEIPT), raised symbols (such as, but not limited to Braille codes), any number of different colors, different texture, or different materials, different physical, electronic, electromagnetic, or optical representation, or any other form of representation that differs from that which is used to manufacture the PRIMARY Ballot, which may include any combination of (but limited to)—any number of Security Elements of claim 6, and any number of other steps, methods, properties, materials or representational forms described in claim 2 that are used to differentiate Primary Registrations from Receipt Registrations shall also be applicable to RECEIPT Ballots from every correlated or non-correlated PRIMARY Ballots; and the further step whereby at least one BALLOT VOTING RSID is comprised of numbers, symbols or a group of numbers and symbols, randomly generated to be of a length, content, and construction as to be extremely difficult to guess by chance or to determine (even when assisted by at least one computer running software programs for such purpose), and the further steps and methods whereby any number of unique codes (such as, but not limited to—a binary digital numeric code, a binary digital ASCII code) are consistently created, assigned, associated, stored, retrieved, communicated and processed according to claim 9, for each unique group combination of BALLOT VOTING RSID numbers, BALLOT VOTING RSID symbols or BALLOT VOTING RSID groups of numbers and symbols; and the further steps and methods whereby each BALLOT VOTING RSID is correlated to any number of, and any type of optically and/or electronically scannable identification marker codes or any other symbolic codes, optical barcodes or electromagnetic codes correlated and attached or embedded to each ballot; and the further steps and methods whereby at most one currently valid PassCode RSID is correlated to each BALLOT VOTING RSID, and whereby at most one currently valid PassCode RSID is immutably recorded and stored with the associated BALLOT VOTING RSID; and whereby the PassCode RSID is comprised of numbers, symbols or a group of numbers and symbols, is randomly generated to be of a length, content, and construction as to be difficult to guess or determine, and the further steps and methods whereby any number of unique codes (such as, but not limited to—a binary digital numeric code, a binary digital ASCII code) are consistently created, assigned, associated, stored, retrieved, communicated and processed according to claim 9 for each unique group combination of PassCode RSID numbers, PassCode RSID symbols or PassCode RSID groups of numbers and symbols, and furthermore that each PassCode RSID is printed, associated or linked with at most, one Primary Ballots, at most each Receipt Ballot or at most one Master Ballot container; and the further steps and methods whereby the Ballot PassCode RSID is hidden from viewing by a removable covering or openable container such that the only way for the PassCode RSID to be viewable will automatically create evidence of having been revealed; and for each Primary Ballot, each Receipt Ballot and each Ballot PassCode RSID of each Master Ballot; the steps and methods of printing, assigning, linking, correlating or embedding any number of Security Elements of claim 6 (such as, but not limited to BALLOT VOTING RSID, Validation RSID, PassCode(s), hologram(s)) for each Ballot (Master, Primary, or Receipt); and the further steps and methods of correlating each Ballot PassCode to any number of, and any type of optically and/or electronically scannable identification marker codes, any other symbolic codes, optical barcodes or electromagnetic codes correlated and attached or embedded to each ballot; and the further steps and methods for each Ballot of allocating identical portions for Voters to mark and record information comprising of, but not limited to—having any number of portions for selecting any number of candidates, any number of portions for selecting any number of proposals, or any number of portions for selecting any number of candidates and any number of proposals; as well as at least one portion containing elements of voting information, correlated to any number of barcodes or other optical scanning markings or electronic processing elements, at least one portion containing additional information; and the further steps and methods for each printed Master Ballot of printing, attaching or embedding, any number of electronic processing elements (such as, but not limited to: magnetic fields, electronic circuits, embedded software programs), optical scanning markings, optical alignment markings or optical skew markings to ensure proper optical scanning, and the further steps and methods of consistently shaping, or cutting away, or marking at least one corner of each Master Ballot (and each Primary Ballot and each Receipt Ballot) so as to identify a consistent orientation (such as, but not limited to: front face in view and top edge uppermost) to assist in sorting, organizing, scanning, counting and any other human, mechanical, optical, electronic, or hybrid processing or other processing according to (but not limited to) claim 9 of any number of Ballots Master, Primary and Receipt); and the further steps and methods for each electronic Ballot (Master, Primary and Receipt) of processing according to (but not limited to) claim 9 to ensure data record quality requirements such as, but not limited to: accuracy, integrity, security and longevity; and the further steps and methods whereby each PRIMARY Ballot and each RECEIPT Ballot part of the Master Ballot is subdivided into, and comprised of, at least one portion, such that, but not limited to: (a) Ballot Header portion—this portion provides information to enable the voter to independently make clearly informed decisions regarding the ballot such as, but not limited to: (a1) the source of the ballot (FIG. 5 item 1A—ballot source, and optionally, FIG. 5—3E1d) and (a2) a unique Voting Session Identifier (FIGS. 5—3F1) which are correlated to any number of, and any type of optically and/or electronically scannable identification marker codes (such as but not limited to: 3E1d to 3E2d, 3F1 to 3F2) or any other symbolic codes, optical barcodes or electromagnetic codes correlated and attached or embedded to each Voting Ballot, so as to facilitate automated processing according to (but not limited to) claim 9; (a3) defining the scope of the ballot application (FIG. 5 item 1B—ballot purpose); (a4) identifying the type of ballot (FIG. 5 item 1C—ballot type); (a5) instruction as to what to do with the completed ballot (FIG. 5 item 1D—completion instructions); (b) Vote Selection portion—this portion provides information to enable the voter to independently make clearly informed decisions regarding the ballot selection options by providing specific information such as (but not limited to): (b1) the title of political position (FIG. 5 item 2A—candidate position description) which may optionally be repeated ad also include a Candidate Position Identifier (FIG. 5—3E1) which is further correlated to any number of scannable barcodes, electromagnetic or optical codes and materials, or other symbolic identifiers (FIG. 53E2) embedded or attached to each Voting Ballot; (b2) description of the voting region the ballot is correlated to, such as, but not limited to: name of the voting region (FIG. 5—2B1) the number of the Voting Region (FIGS. 5—2B2) and the Poll Stations ID (FIGS. 5—2B3), that may optionally be repeated (FIGS. 5—3E1b,c) and further correlated to scannable barcodes (FIGS. 5—3E2b,c) or other symbolic codes so as to facilitate automated processing according to (but not limited to) claim 9; (b3) specific instructions as to how many candidates to select (FIG. 5 item 2C—voting instructions); (b4) to how to properly select the candidates of choice (FIG. 5 item 2D—candidate selection methods); (b5) specific descriptions of the candidates to significantly reduce selection errors FIG. 5 item 2E1—candidate names); (b6) optional description of the candidate political party affiliation (FIG. 5—item 2E2); (b7) correlated candidates selection area for marking (FIG. 5, Item 2E3) the candidate of choice; (c) Ballot ID portion—(c1) Security Elements (FIG. 5—item 3A) according to claim 6, such as, but not limited to: holograms, embedded threads, electronic circuitry are embedded or associated in some way as to be inextricably linked to the Ballot, for the purpose of authenticating the Ballot for the Voting Session; (c2) Ballot Voting Identification (FIG. 5 item 3B1—such as, but not limited to: Random Symbolic Identifier, or, Sequential Symbolic Identifier, or, Group Pattern Sequential ID, or Group Pattern Random Sequential ID which are ALL interchangeably referred to in this version of the patent description as RSID) such that the Ballot ID (a.k.a. Ballot RSID) is comprised of a unique group of symbols which are arranged in a combination that is unique among all Ballot RSID's of each Voting Session, such that each PRIMARY and RECEIPT Ballots that comprise a Master Ballot are uniquely identifiable among all PRIMARY and RECEIPT Ballots of a Voting Session, and for example, is described in (but not limited to) FIG. 5, item 3B1 which is further encoded and correlated to a unique barcode symbol (such as but not limited to) FIG. 5, item 3B2; (c3) Voter Privacy Code (Ballot PassCode RSID) that is used in several ways such as, but not limited to: (c3a) enable the Ballot Voting RSID to be used for voting electronically, and, (c3b) to prevent unauthorized access to electronic reporting of the Ballot Selections for a Ballot Voting RSID; (c4) whereby the Voting PassCode RSID may be optionally hidden (FIG. 5, item 3C1) to enable Ballot Validation without revealing how to enable the Ballot for Voting or access to reporting selections; (c5) whereby the Ballot PassCode RSID is constructed to be sufficiently different in length and composition so as to not be confused with the Ballot Voting RSID; (d) Limits of Use portion—(d1) Expiry Date, Time—(FIG. 5—1C, 3D1,3D2) is the final date and/or time when the Ballot is no longer useful for the Voting Session, and thus must have been received by Officials on or before the Expiry Date to be processed for tallying; and, optionally, any number of Due Dates and/or Due Times for any approved method of voting such as, but not limited to: Internet Voting, Mail Voting, etc; (d2) may also include (b2) of this claim; and (e) the further steps and methods for the any version of any number of MASTER, PRIMARY, or RECEIPT Ballots (or any other objects such as but not limited to: documents, forms or containers) whereby each shall include any number of but not limited to: alignment marks, graphics, electronic encoding, magnetic fields, and/or any form of index identifiers for orientation of optical, magnetic, electronic scanning device(s) so as to facilitate the accurate scanning of data on any ballot in reasonable condition; and (e) the further steps and methods for printed ballots of including such as, but not limited to) a darkened, highlighted or cut-away corner so as to enable identical orientation of ballots for faster preparation for scanning (such as but not limited to FIG. 5—cut 1); and the further steps and methods whereby a removable covering may be applied to the front of a primary ballot or any other document such that the cover obscures non-essential information and also reveals necessary information; (f) and the further steps and methods of encapsulating any number of Voting Ballots and each ballots correlated constituent components so as to facilitate processes such as, but not limited to: physical printing, electronic printing, physical distribution, electronic distribution, physical security, electronic security, ballot contents anonymity, Voter anonymity; (g) and the further steps and methods of marking the external portion of any number of encapsulated Voting Ballots of prior step (f) with any number of, and any type of marking such as, but not limited to optically and/or electronically scannable identification marker codes, symbolic codes, optical barcodes or electromagnetic codes and materials, or any number of security elements of claim 6; (h) and the further steps of correlating, recording and attaching or embedding to each encapsulated ballot of prior step (f) with the identification marker codes, symbolic codes, optical barcodes or electromagnetic codes and materials of prior step (g); (i) and the further steps and methods of decoding and/or encoding and/or evaluating any number of elements of the VOTING RSID to be coordinates to any number of correlated elements within any number of correlated “parent” n-dimensional matrices; (i) and the further steps and methods of providing data decoding, encoding, correlation, comparisons, evaluations for security-authentication of any number of VOTING RSID's and/or and number of Security Elements for any number of Data Security, Data Integrity, Data Storage, Data Transmission methods as may be applied collectively, redundantly or independently according to any number of processing steps and methods such as, but not limited to: VOTING RSID's, Security Elements, Data Storage, Data Security, Data Transmission, Data Reception in accordance with claims 1 to 20 of this invention; (j) and the further steps and methods whereby any number of (but not limited to) the aforementioned steps and methods of claim 3 are used so as to enable rapid automated optical scanning by the steps and methods according to (but not limited to) claims 2 and 9 of this invention.

4. The steps and methods of conducting a Voting Session according to claims 1 to 19 whereby any number of Officials use Voter lists of claim 1 to determine, assign, sort, organize, package, deliver or transmit or otherwise process according to, (but not limited to) claim 9, any number of Master Ballots of claim 2, or, any number of Master Voter Registration Applications of claim 2, or, any number of Master Voter Language forms of claim 2, or any number of other related documents of information or instruction, any number of self-addressed envelopes, any number of postage pre-paid stamped, self-addressed envelopes, and then modifying any number of attributes associated with each Master Ballot or Master Voter Registration Application using computers running programs, along with any number of other steps and methods of (but not limited to) claim 9, as well as permanently recording the issuing of each Master Ballot of claim 2 that is distributed to each Voter on each List of Eligible Voters of claim 1, or each Master Voter Registration Application of claim 2 sent to each Potential Voter on each List of Potential Voters of claim 1 and each Eligible Voter on each List of Eligible Voters of claim 1, or, each Master Voter Language form of claim 2 sent to each Potential Voter on each List of Potential Voters of claim 1 and each Eligible Voter on each List of Eligible Voters of claim 1, and then subsequently modifying and recording any number of attributes associated with each Eligible Voter, each Potential Voter—in correlation with, or independent of, each Master Ballot, each Master Voter Registration Form, each Voter Language Form, each Master Ballot, or any other associated documents or “data containers” that is sent to each Eligible Voter, Potential Voter, Proxy Voter, Official, and each Official entity of the Voting Session.

5. The steps and methods of conducting a Voting Session of claims 1 to 19 whereby Officials according to claims 1 to 5 perform any number of times, for any number of Potential Voters or Eligible Voters of claim 1, the steps and methods such as, but not limited to: determining, assigning, sorting, organizing, packaging, addressing, delivering or transmitting, receiving or accepting, recording and storing, tallying, publishing or otherwise processing according to (but not limited to) claim 9, any number of Master Ballots, or, any number of Master Voter Registration forms, or any number of Master Voter Language forms, or any number of related documents of information or instruction, any number of self-addressed envelopes, any number of postage pre-paid stamped, self-addressed envelopes, using any combination of, but not limited to: in person, by postal service mail, by third party delivery service, by designated representative (proxy), electronically using any number or combination of computers, computer software programs, telephones, facsimile (fax) machines or software, optical scanners, computer programs, audio recording and playback systems, video recording and playback systems, communication networks, cable television systems, electronic mail, encryption and decryption methods, data compression and decompression methods, data organization and retrieval using computers running software programs with any number of methods of (but not limited to) claim 9.

6. The steps and methods of conducting a Voting Session of claims 1 to 19, whereby any number of Potential or Eligible Voters receives any number of Master Ballots of claim 2, receives any number of Voter Registration forms of claim 2, or receives any number of Voter Language Forms of claim 2; and the further steps and methods whereby any number of recipients then verify any number of Ballots, forms or other documents by referring to the Election Information portion, or the Due Date portion, or the Due Time portion, or any other information provided to enable the voter to determine validation and usefulness for any ballot, form, document or container of this invention whereby the confirmation employs, but is not limited to, any number or combinations of—telephones, computers, computer software programs, communications networks, fax machines or fax emulation software, cable television systems, electronic mail, optical scanners, or digital cameras, to transmit and receive ballot or form information, as well as confirmation, rejection, or error messages according to claims 1 to 19 as to the Ballot, form or document validity, to or from, any number Election Officials or designated representatives, as well as any processing according to (but not limited to) claims 1 to 19; and the further steps whereby any number of Eligible Voters confirm authenticity of any number of Master Ballots by referring to any number of unique BALLOT VOTING RSID or any number of Security Elements or any number of published design features common to any number of Master Ballots (and thus Primary and Receipt ballots), any group of Master Ballots or any individual Master Ballot whereby Security Elements (such as but no tlimited to FIG. 5 item 3A, 3C1,3B1,3B2) are not limited to being comprised of any type of, and, any number of: Random Symbolc Identifiers (RSIDs), BALLOT VOTING RSID's, PassCode RSID's, physical characteristics or devices, Braille code embossing, optical structures or devices, holograms, electronic devices or structures, magnetic fields or devices, organic or inorganic chemicals, biological materials, genetic materials or genetic structures or genetic sequences, special materials, crystal structures, plastics, metals, gas emissions, electromagnetic radiation, radioactive materials, optical emissions, natural fibers, man-made fibers, microfilm dots, microscopic writing, embossing, photosensitive symbols, photosensitive text, or photosensitive images, electronic codes, optical codes, optical or digitized pictures, codes embedded within optical pictures or digitized pictures, watermarks, impressions or seals of authenticity integral, affixed or associated, and any other physical, electronic, electromagnetic, optical, chemical or biological structures, devices or properties associated with any number of (but not limited to): Master, Primary or Receipt—Ballots, Voter Registrations, Voter Language Forms or their delivery Containers; and the further steps and methods of creating any number of, and any type of RSID (such as, but not limited to: Random Symbolic Identifier, Sequential Symbolic Identifier, Group Pattern Random Symbolic Identifier, Group Pattern Sequential Symbolic Identifier, etc.) used in any type of object, such as but not limited to ballots, documents, forms, containers; whereby these steps are taken in a logical order such as (but not limited to): (a) valid RSID's created by the Voting Session Officials be kept absolutely secret from all other Voters before and during the voting session; (b) any public RSID used for test trial voting or information purposes should be disallowed in the actual voting records and tallies; (c) to maintain secrecy, before and during the Voting Session, each RSID is known only to the Officials and whomsoever has a PRIMARY or RECEIPT Ballot; (c) defining the maximum number of Random Symbolic Identifiers needed to ensure that any one RSID is unique and extremely difficult to guess. (e.g. but not limited to: 1,000,000,000); (d) officials calculate the number of binary digits needed describe the maximum number of Random Symbolic Identifiers (such as, but not limited to: 24 binary digits gives over 16,000,000 unique combinations); (e) officials by manual cerebral determination or by computers run software programs employing rigorous mathematical concepts to calculate the number of unique RSID symbols needed to enable generating a sufficient number of unique permutations of symbols to be assigned to each Ballot of the Voting Session; (e.g. 2 letters A, B yields 4 unique permutations AA, AB, BA, BB); (f) Officials use existing symbols (such as but not limited to: numbers, characters of an alphabet, etc.) or design new symbols, ensure there is a large set of unique symbolic characters to choose from when randomly selecting and constructing any number of RSIDs and any number of correlated codes; then (g) assign a unique (for example, but not limited to) binary value to each symbol of the set, (h) followed by randomly selecting from the set of unique symbols for the purpose of assembling a unique group of symbols to comprise each RSID, (i) also eliminating symbols that have a similar appearance so as to avoid misinterpretation or confusion by voters, (j) as well as limiting the number of times a single symbol can be repeated in a series of symbols so as to avoid misinterpretation or confusion by voters; (k) Officials then organize each type and group of RSID's so as to be rapidly retrievable with a minimum of processing according to (but not limited to) claim 9 for authentication and validation, which may be accomplished by methods such, but not limited to: merging hybrid implementations of n-tree search methods (such as but not limited to: auto-sort, weighted n-tree beam store, search, retrieval) applied to any number and any type of data storage methods and structures, such as, but not limited to n-dimensional sparse matrices associated to n-dimensional indexed computer databases systems software programs and computers operating system files and operating systems programs running on at least one computer, connected to any number of other computers, using any number of communications methods (such as, but not limited to: local area networks, wide area networks, the internet) employing any number and any type of communication devices (such as, but not limited to: routers, modems, cable modem devices, telephony devices) and security devices and software (such as firewall routers, dongles, security keys, data encryption-decryption software) to effectively and efficiently process the data storage and retrieval as well as to protect the data integrity, longevity and privacy.

7. The steps and methods of conducting a Voting Session according to claims 1 to 19, whereby any number of Voters according to claims 1, 2, 6, 8 perform any number of additional steps according to claims 12, 15, 16 before revealing Ballot PassCode RSID, marking or casting their Ballots of claim 2, to determine whether any number of Master Ballots they are evaluating were not previously used to Vote, and if the Ballot is confirmed as not previously having been used to vote, the Voters exchange, any number of times, any number of Master Ballots they possess for other similar Master Ballots possessed by any number of trusted Eligible Voters or any number of Voting Session Officials or their designated agents, (Inventor comments: This steps and methods are unique among inventions to preserve the anonymity of any Voter, and thus, every Voter, since Voting Session Officials cannot determine which Voters used these steps/methods; In essence, Ballots are like treated like currency, whereby any Eligible Voter can use the Master Ballot, which would be exchanged in kind for an identical Master Ballot in a Voting Region-Zone, as per the Election Rules; Even if a PassCode RSID were revealed, the voter can determine electronically or in person, whether the Master Ballot has already been used to Vote; using hard to fake Security Elements, traceable BALLOT VOTING RSIDs, and dealing with known to be trustworthy people, assist Voters to ensure they exchange their valid, authentic Master Ballot(s) only for other valid, authentic Master Ballot(s)); and the further steps and methods of claims 7, 15 whereby the Voter optionally does NOT open the sealed or encrypted Master Ballot Container to verify the validity of the Ballot; and the further steps and methods of claims 4 to 15 whereby the Voter according to claim 15, does use any number of BALLOT VALIDATION RSIDs, any number of BALLOT VALIDATION PASSCODES, as well as any number of other information and security elements displayed to verify Ballot usability and validity, which may be, but is not limited to: display on the exterior of the sealed Master Ballot container, or, printed on a separate wrapping that is visible through a window of the sealed container, or, encoded as a component of any number of digital files, such as, but not limited to: an encrypted email message with an encrypted file attachment; and the further steps and methods whereby each BALLOT VALIDATION RSID and any number of correlated BALLOT VALIDATION PASSCODES are used to authenticate and verify exactly one Master Ballot Container and any number of MASTER BALLOT VOTING RSIDs within the correlated Master Ballot Container, without revealing any MASTER BALLOT VOTING RSID to anyone handing or exchanging any number of Master Ballot Containers, until such time a Master Ballot Container is opened and any number of MASTER BALLOT VOTING RSID(s) are revealed and further authenticated in correlation with any number of associated BALLOT VALIDATION RSID(s) and any other information associated with the Master Ballots or Master Ballot Container from which the Master Ballot was extracted.

8. The steps and methods of conducting a Voting Session according to claims 1 to 19 whereby any number of Voters who are deemed Eligible Voters or Proxy Voters according to claims 1 to 5, complete any number of Master Registration Forms of claim 2, then keep any number of Receipt Registration forms, then sends, transmits, or delivers in person or by mail or designated third party, or transmits optically, electronically or otherwise transmits according to (but not limited to) claim 9, or by any other acceptable means conveys, any number of Primary Registration forms, Receipt Registration forms or Master Registration forms to any number of Officials or any number of Officially designated Receivers of Registration forms according to the rules of the current Voting Session; and the further steps and methods according to claims 1 to 5 whereby any number of Voters of claim 1, complete any number of Master Language forms of claim 2, then keep any number of Receipt Registration forms, then send, transmit, or deliver in person or by mail or designated third party, or transmits according to (but not limited to) claim 9, or by any other acceptable means conveys, any number of Language Forms Master, Primary, Receipt) to any number of Officials or Designated Receivers according to the rules of the current Voting Session; and subsequently, the further steps and methods according to this claim and claims 6 and 7 whereby each Eligible, Registered Voter then completes any number of Master Ballots whereby each Voter chooses any number of Candidates and/or any number of Proposals on their PRIMARY ballot, whereby they mark may be a circle, X, filled in circle, or whatever other mark, in whatever form (e.g. such as but not limited to: pencil mark, electronic mark) as per Rules of the Voting Session; and the further steps and methods whereby any umber of Voters keep any number of Receipt Ballots that are correlated to their completed PRIMARY Ballot; and the further steps and methods whereby any number of Voters sends, transmits, or delivers, in person or by mail or designated third party, and/or delivers according to (but not limited by) claim 9, or, by any other acceptable means conveys, any number of Primary Ballots, Receipt Ballots or Master Ballots to any number of Officials or any number of Officially designated Receivers of Ballots per Voting Session rules.

9. The steps and methods of conducting a Voting Session according to claims 1 to 19 whereby Officials processing of Ballots, forms, documents or any other form of information comprises of (but is not limited to) the steps and methods of: researching, identifying, defining, designing, verifying, correlating, authenticating, amending, certifying, preparing, organizing, sorting, assembling, recording, storing, printing, publishing, distributing, receiving, creating, assigning, attaching, linking, embedding, encoding, decoding, encrypting, decrypting, compressing, decompressing, converting, accepting, receiving, recording, electronic scanning, optically scanning, recording, enhancing, storing, creating any number of identical duplicate backup copies, correlating, tallying, counting, calculating, correlating, associating, searching, sorting, organizing, marking, labeling, tagging, identifying, acknowledging, error identification, error recording, error correction, error transmission, error reception, error reporting, authenticating, verifying, validating, certifying, summarizing, reporting, communicating, printing, publishing, transmitting, receiving, compressing, decompressing, encrypting, decrypting, interpreting, converting, locating, detecting, reading, receiving, interpreting, translating, transmitting data to, and receiving data from, any number of—humans, legal entities, computers, electronic, mechanical or optical devices, telephones, communications networks and is to include all steps and methods of translating human and device readable codes to modes, protocols or methods of communication, transmission, reception, decryption, encryption, compression, decompression, as well as, (but not limited to) the steps and methods of locating, receiving, detecting, interpreting, translating, reporting, and transmitting error free data, and the further steps of locating, receiving, detecting, interpreting, translating, reporting transmitting, and correcting compromised data, erroneous data, duplicate data or duplicate transmissions; and the further steps and methods, whereby the aforementioned functions, operations and processing of this claim are performed by (but not limited to) any combination and any number of either singularly or any plurality of—Official persons, designated agents, data acquisition devices, electronic, electromagnetic, optical or biological or other computing or analytical devices, communication networks, any other man-made devices, computers, microprocessors, computer software programs, telephones, facsimile (fax) machines, fax software, optical scanners, audio recording equipment, audio playback systems, video recording equipment, video playback systems, communication networks, cable television systems, electronic mail, data encryption methods, data decryption methods, data conversion methods, data reconstruction methods, data compression methods, data decompression methods, data inventory software, data organization software, data tracking software, data retrieval software, printing software, printers, package labeling software and equipment, package identification software, package tracking software, either separately, or, in combination with of any number of (but not limited to) Security Elements of claim 6; and for any number and type of object of this invention, (such as, but not limited to: Ballots, Registration Forms), the further steps and methods to scan any number of groups of human readable words, numbers and symbols that are correlated to each barcode, then comparing each to the information derived from the scanned barcode for mutual corroboration of accuracy, and the further steps of recording the results of comparison and signaling any number and type of error messages.

10. The steps and methods of conducting a Voting Session according to claims 1 to 19, whereby according to claims 6, 7, 8, 9 Officials do accept, receive, acknowledge, sort, organize, record, store, tally, calculate, summarize, print or publish or otherwise process according to claims 1 to 9, any number of Voter Lists of claim 1, any number of Voter Registrations (Master, Primary, Receipts) of claims 2, 7, 8 any number of Voter Language (Master, Primary, Receipts) of claim 2, 7, 8 or any number of Ballots (Master, Primary, Receipts) of claims 2, 7, 8; and the further steps and methods whereby each received Voter Registration form, each Voter Language form, or each Ballot is assigned a new, unique record in a record system which comprises of a new record identifier, date, time, location, and any number of other attributes are updated to describe the receiver and various status conditions for each unique Ballot, Registration or Language form; —any number of Ballots, any number of Voter Registrations, any number of Voter Language forms—of which processing for Ballots includes (but is not limited to), each portion containing any number of candidates, proposals or candidates and proposals correlated with any number of barcodes and further correlated with a portion of the area assigned to mark or record each voter selection, voting information including (but not limited to) at least one voting region identifiers (a.k.a. primary voting zones), any number of subsidiary voting region identifiers (a.k.a. secondary voting regions-zones), any number of polling station identifiers, any number of Postal-Zip Code identifiers, any number of zip codes identifiers, any number of geographic location identifiers, any number of election type identifiers, any number of due date identifiers, any number of due time identifiers, any number of expiry date identifiers, any number of expiry time identifiers, any number of election identification identifiers, any number of other codes or other identifiers, any number of any number of Security Elements, at least one BALLOT VOTING RSID or Registration RSID, any number of PassCode RSIDs, any nuber of Validation RSIDs, any number of Validation PassCodes; —of which processing for any number of Voter Registrations includes (but is not limited to) processing any number of personal identifiers, any number of printed names, any number of signatures, any number of date information, any number of location information; any other Registration information; —of which processing for any number of Voter Language forms includes (but is not limited to) processing any number of personal identifiers, any number of Voter Language Selections information, any number of date information, any number of location information; any other Language information; as well as the steps and methods for each Ballot, Registration or Language form of correlating of each aforementioned identifier or to the respective barcodes or other optical scanning markings or encodings, or electronic processing markings or encodings; and the further steps and methods of creating, assigning, attaching, linking and processing additional encoding for electronic or optical submissions to ensure accurate processing according to claims 8, 9; and the further steps and methods of data storage, retrieval and organization of received Ballots, Voter Registrations and Voter Language forms so as to be easier to record, tally, identify, sort, store, locate, retrieve, publish or otherwise process according to claim 9; and the further steps and methods whereby Officials create, distribute and otherwise process (according to claim 9) any number of acknowledgements for each Master Voter Registrations, Primary Voter Registrations, Receipt Voter Registrations, Master Ballots, Primary Ballots, Receipt Ballots, Master Voter Language forms, Primary Voter Language forms, Receipt Voter Language forms, received from any number of Eligible Voters of claim 1, any number of Potential Voters of claim 1, or any number of Ineligible Voters of claim 1, and any number of designated representatives (proxies) or any other approved legal entities of claim 1; and the further steps and methods whereby Officials receiving any number of PRIMARY Ballots, or, any number of RECEIPT Ballots, or, any number of both PRIMARY Ballots and RECEIPT Ballots, and any number of any other type of object, such as, but not limited to: Voter Registration Form of claim 2; and the further steps and methods whereby at least one Official accepts or rejects the validity and authenticity of each ballot, form, document or container; and the further step of at least one Official validating then accepting any number of AUTHENICATED, VALID documents (such as, but not limited to voter registrations, ballots) for recording and tallying; and the further steps and methods whereby at least one Official determines whether each received documents (such as, but not limited to voter registrations, ballots) were previously processed or recorded in the current Voting Session; and the further steps and methods whereby at least one Official designates any number of verified, authenticated documents (such as, but not limited to voter registrations, ballots) that were submitted only once for the voting session as being CERTIFIED documents (such as, but not limited to voter registrations, ballots); and the further steps and methods whereby all Officials accept only CERTIFIED documents (such as, but not limited to voter registrations, ballots) for recording, tallying, calculating, summarizing, publishing and certifying of interim and final voting session results; and the further steps and methods whereby Officials record, tally, summarize, calculate, certify and publish any number of documents (such as, but not limited to voter registrations, ballots) received by Officials; and the further step of organizing received documents (such as, but not limited to voter registrations, ballots) and any other voter or other information so as to be easy to locate and retrieve for any purpose.

11. The steps and methods, according to claims 9 and 10, whereby any number of times, for each document (such as, but not limited to voter registrations, Voter Language registration form, ballots) or Container (Ballot, Registration) that is created, printed, sent or received and found to contain an RSID or any other ID that is determined to have been previously submitted, the Ballot or form is identified, uniquely marked, recorded, tallied, removed and stored separate from all tallies of valid, authenticated, certified ballots, for further investigation along with all other Ballots sharing the same unique RSID or Voter Registration ID or Voter Language ID, as well as the further steps and methods of determining, any number of times, the truly authentic, valid, certifiable Ballot or Voter Registration, from a group of duplicate submissions, and the further step of restoring each authentic, valid, certifiable Ballot or Voter Registration or Voter Language form to normal processing steps associated with all valid, authentic, certified Ballots, Voter Registrations or Language forms or any other type of Container (such as but not limited to Ballot Container, Registration Container) in any form (such as, but not limited to: paper, electronic file).

12. The steps and methods according to claims 1 to 19 whereby any number of Voters request any number of replacements of any number of Voting Session Items such as, but not limited to: Ballots of claim 3, Registration Forms of claim 2; and the further steps whereby any number of Officials determine, for each Voter, the appropriateness to provide any number of replacement objects for any number of Voters requesting replacements; and the further steps and methods whereby any number of Officials provide any number of replacement items to any number of Voters; and the further steps and methods whereby at least one Official records ALL relevant data regarding the replacement items provided and the recipient voter the item was provided to, so as to accurately amend Official records.

13. The steps and methods of conducting a Voting Session according to claims 1 to 19, whereby according to claim 12, election officials provide unalterable, immutable form (such as a securely stored CDROM Master List) of Crucial Integrity Data Items, such as, but not limited to: the main identification RSIDs for any number of—Ballot(s), Container(s), Voter Registration Form(s), Voter Language Form(s), Voter Information Document(s), or any other Document(s), Form(s), Container(s) or data record(s) of this invention that was used in the Voting Session.

14. The steps and methods according to claims 1 to 13 whereby at least one Official records and provides a receipt for each Eligible Voter of claim 12, or, to each Voter of claim 1, 2, 3, or to any number of Officials, requesting investigation of errors or omissions pertaining to Voter Registrations (Master, Primary, Receipts) or Ballots (Master, Primary, or Receipts) or both Voter Registrations and Ballots, along with all relevant details, then Officials or their designated agents proceed to investigate whether to accept or reject each Voter request to amend any errors, record the Official findings of the investigation, and when required, Officials amend any number of disputed records, tallies, summaries, calculations, and publications for any number of Voter Registrations (Master, Primary, Receipts) or Ballots (Master, Primary, or Receipts), Master Ballot Containers, Voter Information Containers, in accordance with the findings and Voting Session Rules, then any number of times, Officials verify each amendment was completed accurately, or resubmit any number of amendments, then provide a report to each complainant Voter and any number of other interested parties for example, but not limited to: the news media).

15. The further steps and methods of claims 2, and claims 1 to 14, whereby the Master Ballot comprises of a Primary Ballot, at least one Receipt Ballot, at least one unique BALLOT VOTING RSID (that is optionally extremely difficult to guess), and at least one PassCode RSID that is difficult to guess; and the further steps and methods whereby for each Master Ballot, any number of additional BALLOT VOTING RSIDs referred to as VALIDATION RSIDs (VAL-IDs) whereby each VALIDATION RSID is unique among all VALIDATION RSIDs, and each VALIDATION RSID is also unique among all MASTER BALLOT VOTING RSIDs for that election; and the further steps and methods whereby each unique VALIDATION RSID is correlated to exactly one MASTER BALLOT or one MASTER BALLOT CONTAINER and any number of MASTER BALLOTS associated with the MASTER BALLOT CONTAINER; and each VALIDATION RSID is further correlated to any number of MASTER BALLOT VOTING RSIDs within a MASTER BALLOT CONTAINER; and the further steps and methods whereby any number of VALIDATION RSIDs are printed, embedded, attached or otherwise associated with the publicly visible exterior of a Master Ballot Container (such as, but not limited to—a paper envelope, an electronic encrypted container (such as, but not limited to: an encrypted file, a secure webpage, a secure email postbox)) along with any number of details of the voting session (such as, but not limited to—election description, ballot voting political region, poll station ID, candidates, ballot due date and due time, ballot expiry date, etcetera) and any number of Security Elements of claims 2, 6 (such as, but not limited to hologram, embossed letters, official document seal, Ballot VALIDATION RSID) are printed, embedded or otherwise associated and displayed clearly and prominently so as facilitate equitable ballot use and validation for exchanges by clarifying exactly which elections and voting region the Master Ballot Containers internal ballot(s) and Master Ballot PassCodes correspond to, and what time frame these items are useful for; and the further steps and methods whereby if the Master Ballot Container is physical (such as, but not limited to: paper envelope, plastic card with embedded electronic circuits and software (such as but not limited to: Java software enabled smart card keys)), the container is may be perforated along any number of edges or otherwise may be made to access the Ballots without damaging the physical form of the Primary Ballot(s) and Receipt Ballots within; and the further steps and methods whereby if the Master Ballot container is electronic, that the Primary and Receipt Ballot information may not be easily revealed without decryption using any number of VALIDATION PASSCODES (whereby a VALIDATION PASSCODE is similar to a BALLOT PASSCODE however is instead correlated to a specific VALIDATION RSID) and/or other data manipulation steps and methods; and that any number of Security Elements of claims 2, 6 as well as any number of steps and methods of claim 9, may also be implemented consistently and effectively to ensure the protection of sensitive data (for example, but not limited to: information obfusication or encryption/decryption) as well as ensuring other criteria such as, but not limited to: data integrity, accuracy and longevity.

16. The further steps and methods according to claims 4 to 15 whereby to cast a Ballot, any number of Voters opens any number of Master Ballot Containers of claims 15 they possess, and the further steps and methods whereby the Voter is enabled to vote either in person, by mail, electronically or optically after revealing, viewing and using the PassCode RSID found within the Master Ballot Container, or printed on the Primary Ballot or printed on the Receipt Ballot, in conjunction with the BALLOT VOTING RSID for that same Master Ballot, Primary Ballot or Receipt Ballot; and the further steps according to claims 5-15 whereby any number of Voters complete any number of Primary Ballots and retain any number of correlated Receipt Ballots for each Primary Ballot they completed or possess; and the further steps whereby any number of Voters deliver any number of Primary Ballots to Election Officials or Officially Designated Recipients for tallying, as well as any number of identical anonymous copies, (for example, but not limited to: using completed Receipt Ballots by mail or electronic mail or internet website page(s)), to any number of third party individuals, groups, organizations, committees, news media entities, computers and/or any other devices to verify the integrity and accuracy of the Official count of claims 1 to 19; and the further steps and methods, whereby the steps and methods whereby: (a) INTERNET Validation and Internet Voting are performed by any number of Voters such that, but not limited to: (16.a1) use the Internet to connect to at least one Official Internet Voting Website that is secured from unauthorized manipulation; (16.a2) navigate from any number of webpage menus to a secure webpage form used for validation; (16.a3a) where upon accessing this webpage, an Internet Validation Session ID (IVALSID) is created by the Official Computers and correlated to each particular connected Voter; (16.a3b) obtains and utilizes any number of authentication certificates from any number of certificate authorities that are correlated to the respective IVALSID or IVOTSID; (16.a4) whereafter any number of connected Voters then enter a VALIDATION RSID or BALLOT VOTING RSID on their local computer Internet Browser webpage form and submit that form to the Internet Validation System (IVALS) for processing according to (but not limited to) claim 9; (16.a5a) whereafter the IVALS correlates the IVALSID to the RSID submitted, records this information along with, but not limited to: the Voter computer IP address, date and time, (16.a5b) then determines whether there have been statistically numerous RSID submissions from the Voter computer IP address for a given time period, and if so, communicates denial of service to the Voter and stops further processing of the RSID on behalf of that Voter, otherwise (16.a5c) whereby IVALS continues to determine whether the submitted VALIDATION RSID or correlated BALLOT VOTING RSID is valid and any number of other information items; (16.a5c1) whereby if the Voter enters a VALIDATION RSID that is determined to be valid, the voter is shown STATUS information of the Ballot (such as but not limited to: VOTED-OK, READY2VOTE, DISABLED) that is correlated to the VALIDATION RSID, but is NOT shown the BALLOT VOTING RSID, BALLOT PASSCODE nor any BALLOT SELECTIONS made by the Voter; (16.a5c2) whereby if the Voter enters a BALLOT VOTING RSID that is determined to be valid, the voter is shown STATUS information of the Ballot (such as but not limited to: VOTED-OK, READY2VOTE, DISABLED) as well as the VALIDATION RSID, BALLOT VOTING RSID; (16.a5c2a) whereby the IVALS prompts the Voter, a limited number of times, to provide the BALLOT VOTING PASSCODE on a secure form; (16.a5c2b) whereby any number of Official people and/or computers running software programs, determine whether the BALLOT VOTING PASSCODE provided in step (16.a5c2a) is correlated to the BALLOT VOTING RSID of step (16.a5c2); and (16.a5c3) the further steps and methods of (16.a5c2a) to determine whether the number of attempts to provide a VALID BALLOT VOTING PASSCODE has exceeded limitations; and (16.a5c4) the further steps and methods of temporarily disabling the BALLOT if the number of attempts to provide a VALID BALLOT VOTING PASSCODE has exceeded limitations; (16.a6) and the further steps and methods according to this claim, whereby if the Voter enters a BALLOT VOTING PASSCODE RSID that is determined according to step (16.a5c2) to be valid, and the BALLOT VOTING RSID has NOT been disabled according to steps (16.a5c3,4), then the voter receives the VALIDATION RSID, VOTER SELECTIONS and any number of other information items associated with of the BALLOT VOTING RSID; and (16.a7) the further steps and methods according to this claims whereby if the ballot has not been cast, the voter is provided (but not limited to) the options to vote or not vote, and (16.a7a) the further steps and methods of the choice of NOT VOTE, the Voter exits Internet Validation System (IVALS); and (16.a7b) the further steps and methods upon the Voter choice to VOTE: (16.a7b1) the Voter is connected by Official Voting Computer to the Internet Voting System (IVOTS) webpage; (16.a7b2) a unique Internet Voting Session ID is generated, stored and associated with the BALLOT VOTING RSID provided by the Voter; (16.a7b3) the IVOTS provides the Voter with any number of choices such as, but not limited to, any number of: (16.a7b3i) Candidates, (16.a7b3ii) Proposals, (16.a7b3iii) related information items (such as but not limited to: web page hyper-links to Candidate biographies, hyper-links to Candidate political party affiliations and policies, hyper-links to Proposal descriptions), (16.a7b3iv) options to process the Voting form (such as, but not limited to: SUBMIT, CANCEL, RESET, PAUSE, SAVE, EXIT), (16.a7b3v) options to store and communicate selections made, such as, but not limited to: (SAVE2DISK, PRINT, PUBLISH, EMAIL); and (16.a7b4) the further steps and methods whereby the Voter completes and submits their Ballot selections; (16.a7b5) then any number of errors are detected and identified to the Voter by the IVOTS computer software, (16.a7b6) whereby any number of corrections are made, any number of times by the Voter until all the Ballot selections are error free, (16.a7b7) whereby the Voter submits the Ballot Selections for final processing to the IVOTS; and (16.a7b8) the further steps and methods whereby if the Ballot Selections are processed successfully, (16.a7b8i) a unique IVOTS RECEIPT ID is generated, then correlated to the IVOTS Session ID and further correlated to the BALLOT VOTING RSID and BALLOT VOTING PASSCODE, and further correlated to the BALLOT VALIDATION RSID that is correlated to the BALLOT VOTING RSID; and (a7b8ii) the further steps and methods whereby the IVOTS RECEIPT ID, Session ID, BALLOT VOTING RSID, BALOT VOTING PASSCODE, BALLOT VALIDATION RSID, Ballot Selections and any number of other related information items are permanently and redundantly stored, then transmitted securely to, and received by, but not limited to: any number of Election Officials, Political Parties, Candidates, and any number of other approved third parties (such as, but not limited to, independent, non-partisan vote auditors, the news media), for actions such as, but not limited to: verification and accounting in any number of formats (such as, but not limited to: printed, Television Broadcast, electronic file (such as but not limited to: webpage, email, pdf, jpeg) for example, such as but not limited to: using the unique, private Ballot RSID as part of an Internet address to organize and privately store each voter webpage, as well as tallies and summaries of voter selections) employing any number of methods of processing according to (but not limited to) claims 9; and (16.a7b9) the further, optional, steps and methods for each INTERNET Ballot, of detecting, reporting, and stopping processing of appropriate Ballot cast via IVOTS upon detecting NOT timely receiving the PRINTED Primary or Receipt Ballot, or, disregarding any number of failures of delivery of any number of PRINTED PRIMARY or RECEIPT Ballots that are correlated to an INTERNET Ballot cast via the Internet Voting System IVOTS); and the further steps of applying any number of the aforementioned steps and methods, actions, data or results any number of times, to any number of Ballots, Voters, Officials, or other legally recognized entities, by any number of Voters, Officials or other legal entities; and the further steps and methods of this claim (16.b) Telephone Validation whereby: (16.b1) any number of Voters use a telephone to connect to the Telephone Validation System (TVALS); (16.b2a) a Telephone Recording Session TELVALID) is automatically created and correlated to the Telephone Validation Session; (16.b2b) obtains and utilizes any number of authentication certificates from any number of certificate authorities that are then correlated to the TELVALID; (16.b3i) any number of recording devices are automatically connected and record the Telephone Validation Session; and (16.b3ii) optionally, the Voter Telephone Number to detect issues such as, but not limited to: excessive RSID guessing; (16.b4) the voter uses the telephone keypad, verbally words, or any other acceptable methods to navigate through any number of menus and any number of menu options to interact with the validation menu; (16.b5) each Voter then uses an approved method (such as, but not limited to: keypad tones, verbal words, text message menu option selections) to enter a BALLOT VALIDATION RSID or BALLOT VOTING RSID; (16.b6) the TVALS records the RSID and correlates it to the TELSID along with the date, time and optional voter telephone number; (16.b7) TVALS then determines whether any statistically significant issues are related to the voter telephone number or RSID provided, and if so, then communicates denial of service to the voter, otherwise, (16.b8) proceeds to determine whether the BALLOT VALIDATION RSID or correlated BALLOT VOTING RSID are valid along with any number of other information items; (16.b8i) whereby if the Voter enters a BALLOT VALIDATION RSID that is determined to be valid, the voter is informed of the STATUS information of the Ballot (such as but not limited to: VOTED-OK, READY2VOTE, DISABLED) that is correlated to the BALLOT VALIDATION RSID, but is NOT informed of the BALLOT VOTING RSID, BALLOT PASSCODE nor any BALLOT SELECTIONS made by the Voter, and if a valid BALLOT VALIDATION RSID correlated to valid, enabled, BALLOT VOTING RSID was provided by the voter, the voter is given the option to vote via telephone such that on selecting the choice to NOT VOTE, the voter then exits the Telephone Validation System; otherwise, on selecting VOTE, the Voter is connected to the Telephone Voting System and asked to provide a BALLOT VOTING RSID; (16.b8ii) whereby if the Voter enters a BALLOT VOTING RSID that is determined to be valid, the voter is informed of the STATUS information of the Ballot (such as but not limited to: VOTED-OK, READY2VOTE, DISABLED) as well as the BALLOT VALIDATION RSID, BALLOT VOTING RSID; (16.b8ia) a Telephone Voting Session (TELVOTID) is automatically created and correlated to the Telephone Validation Session; (16.b8ib) TELVOTS or any number of Voters obtains and utilizes any number of authentication certificates from any number of certificate authorities that are then correlated to the TELVOTID; (16.b8ic) any number of recording devices are automatically connected and record the Telephone Voting Session; and (16.b8id) optionally, the Voter Telephone Number to detect issues such as, but not limited to: excessive RSID guessing; (16.b4) the voter uses the telephone keypad, verbally words, or any other acceptable methods to navigate through any number of menus and any number of menu options to interact with the validation menu; (16.b8iia) whereafter the TVALS prompts the Voter, a limited number of times, to provide the BALLOT PASSCODE; (b8iib) whereafter the Voter provides a PassCode, preferably the one correlated to the BALLOT VOTING RSID; (b8iic) whereafter any number of officials determine whether (1) the BALLOT PASSCODE provided by the Voter is correlated to the BALLOT VOTING RSID thus is VALID, (2) the number of attempts to provide a VALID BALLOT PASSCODE has exceeded limitations which results in disabling the BALLOT; (16.b8iid) whereby if the Voter enters a BALLOT PASSCODE RSID that is determined to be valid, and the BALLOT VOTING RSID has not been disabled, the voter receives the VALIDATION RSID, VOTER SELECTIONS and any number of other information items associated with of the BALLOT VOTING RSID and (16.b8ie) if the ballot has not been cast, the voter is provided with (but not limited to) the options to vote or not vote; (16.b8iie1) whereupon the choice of NOT VOTE, the Voter exits Internet Validation System (IVALS); (16.b8iie2) otherwise upon the Voter choice to VOTE: (1) the Voter is connected by Official Voting Computer to the Telephone Voting System (TVOTS), (2) a unique Telephone Voting Session ID is generated, stored and associated with each BALLOT VOTING RSID provided by the Voter; (3) the TVOTS provides each Voter with any number of choices such as, but not limited to: (4i) Candidates, (4ii) Proposals, (4iii) related information items (such as but not limited to: menu-options for Candidate biographies, menu options to Candidate political party affiliations and policies, menu-options to Proposal descriptions), (4iv) menu options to process the Voting form (such as, but not limited to: SUBMIT, CANCEL, RESET, SAVE, EXIT); (4v) menu-options to store and communicate selections made, such as, but not limited to: (SAVE2DISK, PRINT, PUBLISH, EMAIL); and (5) the further steps and methods whereby the Voter completes and submits their Ballot selections then any number of errors are detected and identified to the Voter by the IVOTS computer software, (6) whereafter any number of corrections are made, any number of times by the Voter until all the Ballot selections are error free; (7) whereafter the Voter submits the Ballot Selections for final processing to the IVOTS; (8) if the Ballot Selections are processed successfully, a unique IVOTS RECEIPT ID is generated, then correlated to the IVOTS Session ID and further correlated to the BALLOT VOTING RSID and BALLOT PASSCODE, and correlated to the VALIDATION RSID that is correlated to the BALLOT VOTING RSID; (9) the IVOTS RECEIPT ID, Session ID, BALLOT VOTING RSID, BALLOT PASSCODE, VALIDATION RSID, Ballot Selections and any number of other related information items are permanently and redundantly stored, then transmitted securely to, and received by, but not limited to: any number of Election Officials, Political Parties, Candidates, and any number of other approved third parties such as, but not limited to, independent, non-partisan vote auditors, the news media), for actions such as, but not limited to: verification and accounting in any number of formats (such as, but not limited to: printed, Television Broadcast, electronic file (such as but not limited to: webpage, email, pdf, jpeg) for example, such as but not limited to: using the unique, private Ballot RSID as part of an Internet address to organize and privately store each voter webpage, as well as tallies and summaries of voter selections) employing any number of methods of processing according to (but not limited to) claims 9; and (16.b9) the further, optional, steps and methods for each TELEPHONE Ballot, of detecting, reporting and stopping processing of the appropriate TELEPHONE Ballot cast via TVOTS upon detecting NOT receiving the PRINTED form of the Primary or RECEIPT Ballot(s), or, disregarding any number of failures of delivery of any number of PRINTED PRIMARY or RECEIPT Ballots that are correlated to a TELEPHONE Ballot cast via the TVOTS; and the further steps of applying any number of the aforementioned steps and methods, actions, data or results any number of times, to any number of Ballots, Voters, Officials, or other legally recognized entities, by any number of Voters, Officials or other legal entities; and (16.c) the further steps and methods of Validation and Voting by Fax or Email whereby the Voter follows in general the modified previous steps and methods of (but not limited to) Internet and Telephone Validation and Voting, such that any number of Voters generally do, but are not limited to: (16.c1a) obtains and utilizes any number of authentication certificates from any number of certificate authorities; (16.c1b) uses a facsimile device or computer running facsimile software or document processing software or email software or any other combination of devices and/or software in conjunction with any number of and types of communications system and methods according to (but not limited to) claim 9, to connect to the FAX-EMAIL Validation System (FEVALS); (16.c2a) whereupon successfully connecting, a unique FAX-EMAIL Validation ID (FEVALID) is generated and associated with the fax-email session; (16.c2b) FEVALS and/or any number of Voters obtains and utilizes any number of authentication certificates from any number of certificate authorities that is correlated to each respective, originating FEVALID; (16.c3) the type of connection is determined (FAX or EMAIL) and is logged along with the date, time, and optionally, the Voter telephone number or email address; (16.c4a) the Voter then submits the VALIDATION RSID to the FEVALS; (16.c4b) whereafter the FEVALS receives the VALIDATION RSID, or BALLOT VOTING RSID, then employs any number of steps and methods according to but not limited to) claim 9 along with computers running software for optical image and character recognition so as to securely receive and process the faxed or emailed data (such as, but not limited to: faxed image of validation data, email text data, email attached data file, such as, but not limited to PDF image file) to validate any number data items (such as, but not limited to RSID(s) or Security Elements, PassCodes), using any number of computers, running computer software programs such as, but not limited to: optical character recognition software; (16.c5) whereby officials transmits the validation results to the voter, using the appropriate communication method based on the type of connection or desired response method (EMAIL, FAX or optional VOICE MESSAGE or TEXT MESSAGE); (16.c6) whereby the Voter then receives the validation status of the ballot, form, document or container, as to whether it is valid and if so, whether the item has already been used; (16.c7) if the BALLOT VOTING RSID was provided and was determined not to have been previously used and the ballot is enabled to be cast, the Voter FAX-EMAIL is automatically connected to any number of Fax-Email Voting System (FEVOTS) computers and/or Officials and automatically exited from the Facsimile-Email Validation System (FEVALS); (16.c8) whereby, for each BALLOT VOTING RSID received, the FEVOTS does: (16.c8a1) create a FAX-EMAIL Voting Session ID (FEVOTID) that is then correlated to the BALLOT VOTING RSID then stored and processed according to (but limited to) claim 9; (16.c8a2) FEVOTS and/or any number of Voters obtains and utilizes any number of authentication certificates from any number of certificate authorities that is correlated to each respective, originating FEVOTID; (16.c8b) the FEVOTS then provides a limited number of opportunities to enter the correct Ballot PassCode before locking out the BALLOT VOTING RSID from voting until released by Election Officials; (16.c8c) scan the message to determine whether there is an image file of the Ballot showing Voting Selections of Candidates, Proposals, or other choices, along with the Ballot Voting PassCode and (16.c8d) if any number of these items are found, then the FAX-EMAIL Voting System (FEVOTS) enacts the steps and methods of (but not limited to) claim 9, to determine if the submitted BALLOT VOTING PassCode provided is valid, (16.c8e1) such that in the case the Ballot PassCode was incorrect, the Voter is notified of denial of Voting, and no further processing of the Ballot occurs, otherwise, (16.c8e2) if the FEVOTS determines the Ballot PassCode DOES correlate to the BALLOT VOTING RSID, then: (1) the methods whereby the FEVOTS employs any number of people, and any number of computers running software programs (such as, but not limited to optical character recognition programs) to determine exactly which candidates, proposals or other choices were selected on the Ballot; (2) the further steps and methods whereby any number of errors are detected and identified to the Voter by the IVOTS computer software, and any other processing according to (but not limited to) claim 9; (3) whereafter any number of corrections are made, any number of times by the Voter until all the Ballot selections are error free; (4) whereafter the Voter submits the Ballot Selections for final processing to the IVOTS; (5) if the Ballot Selections are processed successfully, a unique IVOTS RECEIPT ID (IVOTRECID) is generated, then correlated to the IVOTS Session ID and further correlated to the BALLOT VOTING RSID and BALLOT PASSCODE, and correlated to the VALIDATION RSID that is correlated to the BALLOT VOTING RSID; (6) the IVOTS RECEIPT ID, Session ID, BALLOT VOTING RSID, BALLOT VOTING PASSCODE, BALLOT VALIDATION RSID, Ballot Selections and any number of other related information items are permanently and redundantly stored, then transmitted securely to, and received by, but not limited to: any number of Election Officials, Political Parties, Candidates, and any number of other approved third parties such as, but not limited to, independent, non-partisan vote auditors, the news media), for actions such as, but not limited to: verification and accounting in any number of formats (such as, but not limited to: printed, Television Broadcast, electronic file (such as but not limited to: webpage, email, pdf, jpeg) for example, such as but not limited to: using the unique, private Ballot RSID as part of an Internet address to organize and privately store each voter webpage, as well as tallies and summaries of voter selections) employing any number of methods of processing according to (but not limited to) claims 9; and (16.c9) the further, optional, steps and methods for each FAX-EMAIL Ballot, of detecting, reporting and stopping processing of the appropriate FAX-EMAIL BALLOT cast via FEVOTS upon detecting failure of timely receipt of the PRINTED Primary or Receipt Ballot, or, disregarding any number of failures of delivery of any number of PRINTED PRIMARY or RECEIPT Ballots that are correlated to a FAX-EMAIL Ballot cast via the FEVOTS; and the further steps of applying any number of the aforementioned steps and methods, actions, data or results any number of times, to any number of Ballots, Voters, Officials, or other legally recognized entities.

17. The steps and methods according to claims 1 to 16 whereby Officials provide steps and methods for each Ballot, Voter Registration, Voter Language Form, or any other items related to the Voting Session that is received, such that a certified copy is made available to at least one Eligible Voter for verification and error detection, and that at least one means, method and opportunity of reporting errors is provided, and the further steps and methods whereby any number of Officials, or any number of Eligible Voters, or at least one designated representative (proxy) that possess the unique combination of the BALLOT VOTING RSID and PassCode RSID for each disputed Voter Registration or Ballot submits the Voter Registration or Ballot electronically to Officials E) v) c) iv) Officials select one MASTER Ballot, designated as a REPLACEMENT Ballot, for each Ballot that was CANCELLED; whereby each REPLACEMENT Ballot is identical to the CANCELLED ballot, except for at least one Random Symbolic Identifier of the REPLACEMENT Ballot being distinctly different from every Random Symbolic Identifier of the CANCELLED Ballot; each REPLACEMENT Ballot is tested to be both VALID and AUTHENTIC; each REPLACEMENT Ballot passing tests of preceding steps has a Verification Status designated as ACTIVE;
E) v) c) v) at least one Official delivering, or arranging the delivery of, a correlated number of REPLACEMENT Ballots to each Applicant; whereupon the Ballot is now designated as a MASTER ballot; furthermore, the Delivery Status attribute of each delivered REPLACEMENT Ballot becomes DELIVERED;
E) v) c) vi) any number of Officials record the quantity and type of REPLACEMENT-MASTER Ballots delivered to every Applicant;
E) v) c) vii) any number of Applicants receive any number of uniquely different REPLACEMENT—MASTER ballots of the same type submitted for replacement;
E) v) c) viii) Any Eligible Voter or Official may obtain a replacement MASTER ballot in exchange for any LOST or STOLEN ballot having an Activity Status of ACTIVE;
E) vi) a) any number of Voters (Applicants) or Officials (Applicants) deliver any number of MASTER, PRIMARY, PHONE, INTERNET Ballots to any number of Officials;
E) vi) b) Officials receive any number of Ballots of the preceding steps;
E) vi) c) Officials record at least the names and address of each Applicant requesting Ballot Replacement; recording the date and time of filing the Affidavit along with additional identification such as social security number, drivers license number;
E) vi) d) any number of Officials provides any number of Applicants with at least one Affidavit form for the purpose of declaring a Ballot to be either LOST, or, STOLEN;
E) vi) e) each Applicant completes the Affidavit of previous step E)Vi)d) whereby:
E) vi) f) each Applicant provides their full legal name with the Affidavit;
E) vi) g) each Applicant provides their address, when applicable, with their Affidavit;
any number of Voters notify Officials to investigate and correct any number of errors discovered; and the further steps and methods whereby at least one Official records each Voter request to investigate, with all relevant details; and the further steps and methods whereby any number of Officials proceed to investigate whether to accept or reject each Voter request to amend any number of errors, then report to any number Voters and/or authorized legal entities, as to whether an amendment is required as requested, along with each Official findings of the investigation which is all duly recorded in the official records; and the further steps and methods if required, whereby at least one Official then amends the records, tallies, summaries, calculations, and publications to correct the records and tallies of any number of PRIMARY Ballots, or voter selections made on the PRIMARY Ballots, in accordance with the findings and the Rules of the Voting Session; and the further steps and methods whereby at least one Official verifies any amendments were completed accurately; and the further steps and methods whereby at least one Officials records in the Official records, and reports to any number of Voters or other interested legal entities as to when the amendments are completed, along with the results of the Official verification of the amendments; and the further steps and methods whereby at least one Official provides each Voter with at least one method, and at least one opportunity, to accept or reject the accuracy of any amended records, tallies, summaries, calculations, or publications; and the further steps and methods whereby any number of Voters verify correctness or report errors of any number of amendments (with or without corrective data) to any number of Officials.

18. The steps and methods according to claims 1 to 20 of this invention whereby any number of Officials and/or any number of third-parties provide services such as, but not limited to: (18.a) Official Computer Authentication—the steps and methods whereby any number of voters using computers, telephones or any other devices are provided with—any number of secure telephone lines, internet connections (such as, but not limited to: HTTPS, SSL) and any amount of computer authentication data issued by a third party certificate authority so as to validate the authenticity of the official computers and communications systems being used for voting and communications are legitimate and authorized for use; and the further steps and methods whereby:
(18.b) hacker protection—the steps and methods whereby any number of official computers, telephones or any other devices and communications systems are provided with enhanced security software, equipment, personnel and procedures to ensure the electronic voting systems availability and reliability for use for authorized users, and the further steps and methods of providing any number of security measures to ensure the integrity and reliability of the voting system processes, such as, but not limited to, any number of: data transmissions, data receptions, data error corrections, document processing (such as, but not limited to: document validations, certifications, calculations and publications); and the further steps and methods whereby:
(18.c) Internet Identity Masking—the steps and methods whereby any number of voters using computers connected to the internet for voting employ IP (internet provider) masking to hide their unique voter internet address identity by enabling each internet voter to appear as another unrelated IP address to any number of election computers; and the further steps and methods whereby IP masking employs (but is not limited to) software from third parties that connect to commercial or privately owned computer and routers so as to use the third party IP addresses as an alias for the voter, &/or connect any number of public or private masking network systems (such as but not limited to: JAP, TOR) whereby internet routers encrypt the data and originating voters IP address so as to hide the voters data from Internet users and further hide each voter's original IP and computer identity from the election computer systems; and the further steps and methods whereby:
(18.d) Voting Receipt Encryption—to ensure data integrity of receipt ballots by reducing the possibility of falsification and ballot tampering—the steps and methods whereby any number of election computers encrypt any number of ballot receipt information (such as, but not limited to: ballot RSID, voter selection validation codes, receipt sequence ID, receipt validation code, date and time stamp) so that any number of public encrypted ballot receipt codes (PUB-EBRC) are created to obscure the original ballot receipt voting information by using at least one private encryption digital number (a private encryption key: PRI-KEY) and a private encryption algorithm (PRI-ENALG), and the further steps and methods whereby each original ballot receipt information is recoverable from the correlated public encrypted ballot receipt code (PUB-EBRC) by applying manually or by computer, the correlated private receipt encryption key (PRI-KEY) and the correlated private receipt encryption algorithm (PRI-ENALG) to the correlated public encrypted ballot receipt code (PUB-EBRC);
and the further steps and methods, such as but not limited to:
i) whereby any number of public encrypted ballot receipt codes (PUB-EBRC) are each correlated to their respective ballot RSID;
ii) whereby any number of public encrypted ballot receipt codes (PUB-EBRC) are then optionally printed on the face of the ballot;
iii) whereby any number of ballot information data elements are NOT printed on each ballot to preserve privacy of data (such as, but not limited to: ballot RSID);
iv) whereby any number of private encryption algorithms (PRI-ENALG) of this step are unique overall this invention and at least at least one private encryption key (PRI-KEY) is unique for each PRI-ENALG of this invention;
v) whereby any number of public encryption algorithms (PUB-ENALG) and public encryption keys (PUB-KEY) are provided and employed to enable general public validation of ballot receipts data and ballot receipt codes without revealing the private encryption algorithms (PRI-ENALG) or private encryption keys (PRI-KEY).
vi) whereby to facilitate machine scanning, any number of barcodes and/or other symbolic marking codes are generated and correlated to any number of ballot information data elements and any number of public encrypted ballot receipt codes, then printed on or otherwise incorporated into the ballot receipt;
vii) whereby to facilitate machine scanning, any number of geometric shapes, lines and/or other symbolic marking codes to be used for orientation or alignment are generated then printed on, or otherwise incorporated into the ballot receipt;
and the further steps of any combination of any number of other steps, methods and processes employing people, procedures, software or equipment so as to ensure accuracy, integrity and availability of the voting system.

19. The steps and methods according to claims 1 to 18 of this invention whereby any number of Officials generate any number of internet webpages correlated to each voter registration via at least one registration ID; and the further steps and methods whereby any number of Officials generate any number of internet webpages correlated to each Primary Ballot via one unique Ballot Voting RSID or SID; and the further steps and methods whereby a voter can use any number of electronic devices of this invention such as, but not limited to: computers, cell phones, PDA's) the Internet and/or any number of other communications methods of this invention to securely access, input, verify, validate, review, amend, print and save copies of, and/or securely submit—personal information to complete at least one voter registration, and any number of other forms or documents pertaining to the voting session and voter, that are then submitted privately and securely to Officials for evaluation; and the further steps and methods whereby a voter may apply the same or similar electronic devices and communications systems of claims 1 to 18 of this invention so as to securely access, verify, validate, input, amend, review, print or save copies of, and/or securely submit any number of Primary Ballots to Officials by providing all necessary data (such as, but not limited to: Ballot Voting RSID, Ballot PassCode) relevant to Ballot status (such as, but not limited to: ready2vote, votedOK, Cancelled) so as to enable reviewing or casting of any number of ballots for each registered voter, proxy or appointees; and the further steps and methods according to claims 1 to 18 whereby Officials and Voters repeat any number of steps 1 to 18, any number of times, for any number of voting entities, non-voting entities or officials until satisfactorily completing all requirements according to Voting Session Rules; and the further steps and methods according to claims 1 to 18 whereby Officials then verify, validate, certify then finalize then publish the final amended records, tallies, calculations, summaries and reports pertaining Voter Registrations, Ballots, and any other relevant aspect of the Voting Session, and the further steps and methods of providing any number of information items (such a, but not limited to: list of all Eligible Voters, list of all Ballot Voting RSIDs) to Voters, political candidates, and interested third parties (such as, but not limited to: news media, non-partisan vote auditors, non-voters) in accordance with the Rules of the Voting Session; and the further steps whereby at least one Official declares the Voting Session as completed.

20. The inventor also claims the further steps, and methods, as another embodiment or application of this invention, as previously filed by this inventor in U.S. patent Pending Ser. No. 11/160,003 for which the inventor also claims foreign filing priority according to the Paris Convention Treaty for Canadian Patent Pending 2,700,498 whereby: the steps and methods according to (but limited to) claims 1-19 of this invention include any further methods of providing, tracking, auditing, tallying and reporting any type of and any number of RSID's according to (but not limited to) claim 3, correlating any number of barcodes or other symbolic codes to each Random RSID, any number of Security Elements according to (but not limited to) claim 6, any number of steps and methods of processing according to (but not limited to) claims 1 to 19, to any number of objects (such as, but not limited to: documents, money orders, vehicles, electronic mail, electronic files, internet webpages) in any number of formats (such as, but not limited to: electronic file, internet webpage, printed paper, embossed plastic) to enable any number and any type of actions—such as, but not limited to: object registration, tracking, auditing, determination of existence/status, recording events, statistical analysis (such as, but not limited to: locations, timing, frequency), signaling warning messages, generating reports of events and/or analysis.
